(19) United States
(12) Patent Application Publication
(10) Pub. No.: US 2025/0328024 A1
(43) Pub. Date: Oct. 23, 2025

(54) COMPACT LIGHT PROJECTION DEVICE WITH NONLOCAL METASURFACE SPACE COMPRESSOR

(71) Applicant: Meta Platforms Technologies, LLC, Menlo Park, CA (US)

(72) Inventor: Mantas ZURAUSKAS, Redmond, WA (US)

(73) Assignee: Meta Platforms Technologies, LLC, Menlo Park, CA (US)

(21) Appl. No.: 19/051,668

(22) Filed: Feb. 12, 2025

Related U.S. Application Data
(60) Provisional application No. 63/637,647, filed on Apr. 23, 2024.

(51) Int. Cl. G02B 27/01

(52) U.S. Cl. CPC G02B 27/0179; G02B 27/0172; G02B 2027/0178; G02B 2027/0187

(57) ABSTRACT

Apparatuses, systems, methods, and systems/methods of manufacturing a compact light projection device with one or more nonlocal metasurface space compressors, suitable for use in an eye/face tracking system of a near-eye device, are described. In one aspect, an eye/face tracking system may have a light source, a nonlocal metasurface space compressor to receive light from the light source, modify said light, and project the modified light, and a beam forming element to receive and project the modified light as the structured light onto the user's eye and/or surrounding facial tissue.

### CROSS-REFERENCE TO OTHER APPLICATIONS

This application claims priority under 35 U.S.C. § 119 to U.S. Prov. Pat. App. Ser. No. 63/637,647 entitled “COMPACT LIGHT PROJECTION DEVICE WITH NONLOCAL METASURFACE SPACE COMPRESSOR” and filed on Apr. 23, 2024, the entire contents of which are incorporated herein by reference.

### TECHNICAL FIELD

This patent application relates generally to eye and/or face tracking in near-eye display devices, and in particular to a compact light projection system for eye and/or face tracking having one or more nonlocal metasurface space compressors.

### BACKGROUND

With recent advances in technology, the prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an augmented reality (AR) system, a user may view both images of virtual objects (e.g., computer-generated images (CGIs)) and the surrounding environment. Head-mounted display (HMD) devices may also present interactive content, where a user's (wearer's) gaze may be used as input for the interactive content.

Wearable display devices, such as virtual reality (VR), augmented reality (AR), and/or mixed reality (MR) glasses, may require increasingly complex and intricate lens assembly structures, as well as increasingly complex and intricate electronic structures, etc., thereby complicating, inter alia, the manufacturing process. Moreover, the need for both electronics and optics to have a relatively small size and negligible weight for portability and user comfort, as well as the ability to operate in a wide variety of environments, produces a host of challenges and competing concerns, in areas such as, for example, eye and/or face tracking.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a near-eye display device which may form part of a display system environment, according to an example.

FIGS. 2A and 2B illustrate a front prospective view and a back prospective view, respectively, of a near-eye display device in the form of a head-mounted display (HMD) device to which examples of the present disclosure may be applied.

FIGS. 3A and 3B illustrate a perspective view and a top view, respectively, of a near-eye display device in the form of a pair of glasses to which examples of the present disclosure may be applied.

FIGS. 4A-4D illustrate properties, constructions, and characteristics of nonlocal metasurface space compressors, according to which examples of the present disclosure may be employed.

FIG. 5A illustrates a light projection system for eye and/or face tracking in a near-eye device, which includes a nonlocal metasurface space compressor, according to an example of the present disclosure.

FIG. 5B illustrates a compact light projection system for eye and/or face tracking in a near-eye device, which includes a nonlocal metasurface space compressor, according to an example of the present disclosure.

FIG. 6 illustrates a monolithic compact light projection system for eye and/or face tracking in a near-eye device, which includes a nonlocal multilayer polymer spaceplate, according to an example of the present disclosure.

FIG. 7 illustrates a monolithic compact light projection system for eye and/or face tracking in a near-eye device, which includes a polarization-sensitive spaceplate for focal depth extension, according to an example of the present disclosure.

FIG. 8 illustrates a monolithic compact light projection system for eye and/or face tracking in a near-eye device, which includes a polarization-sensitive spaceplate and a polarization-sensitive camera for depth encoding, according to an example of the present disclosure.

FIG. 9 is a flowchart illustrating a method for eye and/or face tracking using a light projection system including one or more nonlocal metasurface space compressors, according to an example of the present disclosure.

FIG. 10 is a flowchart illustrating a method for manufacturing a monolithic compact light projector having a nonlocal metasurface space compressor/spaceplate, which may be employed for eye and/or face tracking in a near-eye device according to examples of the present disclosure.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

As used herein, a “wearable device” may refer to any portable electronic device that may be worn on any body part of a user and used to present audio and/or video content, control other devices, monitor bodily functions, and/or perform similar actions. As used herein, a “near-eye device” may refer to a device that may be in close proximity to a user's eye and may have optical capabilities, whereas a “near-eye display device” may refer to a device that may be in close proximity to a user's eye and may be capable of some sort of display to one or both of the user's eyes. Accordingly, a near-eye display device may be a head-mounted display (HMD) device, such as a wearable eyewear, a wearable headset, and/or “smartglasses,” which may be used for interacting with virtual reality (VR), augmented reality (AR), mixed reality (MR), and/or any environment of real and/or virtual elements, such as a “metaverse.” As used herein, a “user” may refer to a user or wearer of a “wearable device,” “near-eye device,” and/or “near-eye display device,” depending on context, which would be clear to one of ordinary skill in the art.

Size is a problem for all of the components in a near-eye device, particularly a near-eye display device, such as a virtual reality (VR), augmented reality (AR), and/or mixed reality (MR) near-eye display device in the form of a pair of eyeglasses, sometimes referred to as “smartglasses,” where space for active and optical components are at a premium. Accordingly, it may be beneficial to reduce the size of any components in a near-eye device-such as the lighting components for eye and/or face tracking in a near-eye device (which are described and discussed in detail below). Reducing the size of the eye and/or face tracking lighting system would have many advantages in, for example, manufacturing, the form factor of the near-eye device, user comfort (its bulkiness, the weight upon the user, etc.), overall system efficiency, the ability to increase the resources available for other components, etc.

According to examples of the present disclosure, nonlocal metasurface space compressors, such as spaceplates, multilayer metasurfaces/metalenses, and other optical components which take advantage of nonlocal flat optics, may greatly reduce the size of the eye and/or face tracking light projection system in a near-eye device.

According to examples of the present disclosure, a compact eye and/or face tracking light projector including one or more nonlocal metasurface space compressors, and methods for using and manufacturing the same, are described herein. In some examples, the nonlocal metasurface space compressor may be a spaceplate or multilayer metasurfaces made of amorphous silicon and/or other silica (e.g., Silicon Dioxide (SiO₂), Silicon Nitride (SiN), etc.). In some examples, the nonlocal metasurface space compressor may be a “sandwich” of a waveguide between two different metasurface layers, or multiple layers of alternating waveguides and metasurfaces.

According to examples of the present disclosure, a compact eye and/or face tracking light projector including a nonlocal metasurface space compressor may provide both a wider beam of illumination than a conventional eye and/or face tracking light projection system and a smaller form factor than a conventional eye and/or face tracking light projection system.

According to examples of the present disclosure, a compact eye and/or face tracking light projector including a nonlocal metasurface space compressor may be relatively uncomplicated to manufacture using lithography, as well as less costly, depending on the type, construction, and specific implementation of the nonlocal metasurface space compressor.

While some advantages and benefits of the present disclosure are discussed herein, there are additional benefits and advantages which would be apparent to one of ordinary skill in the art.

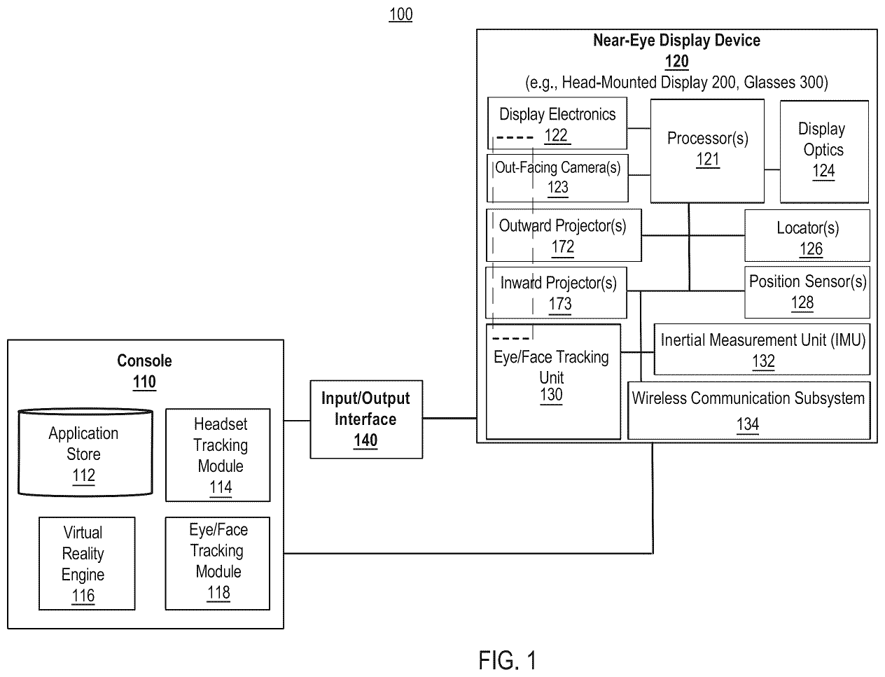

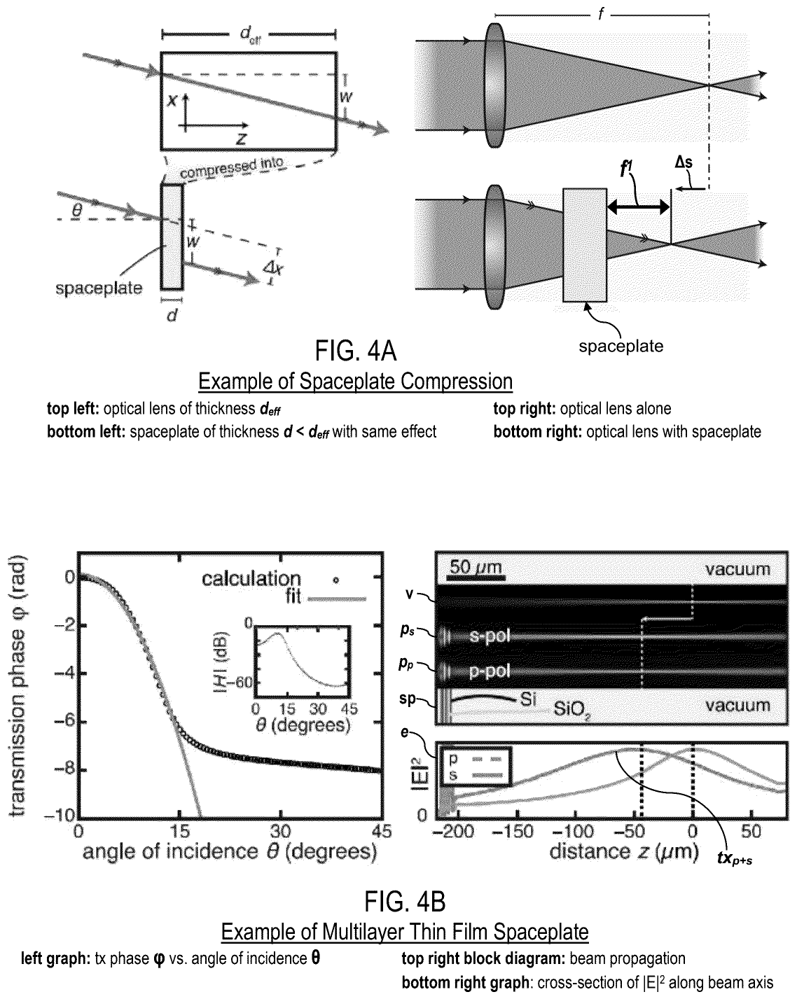

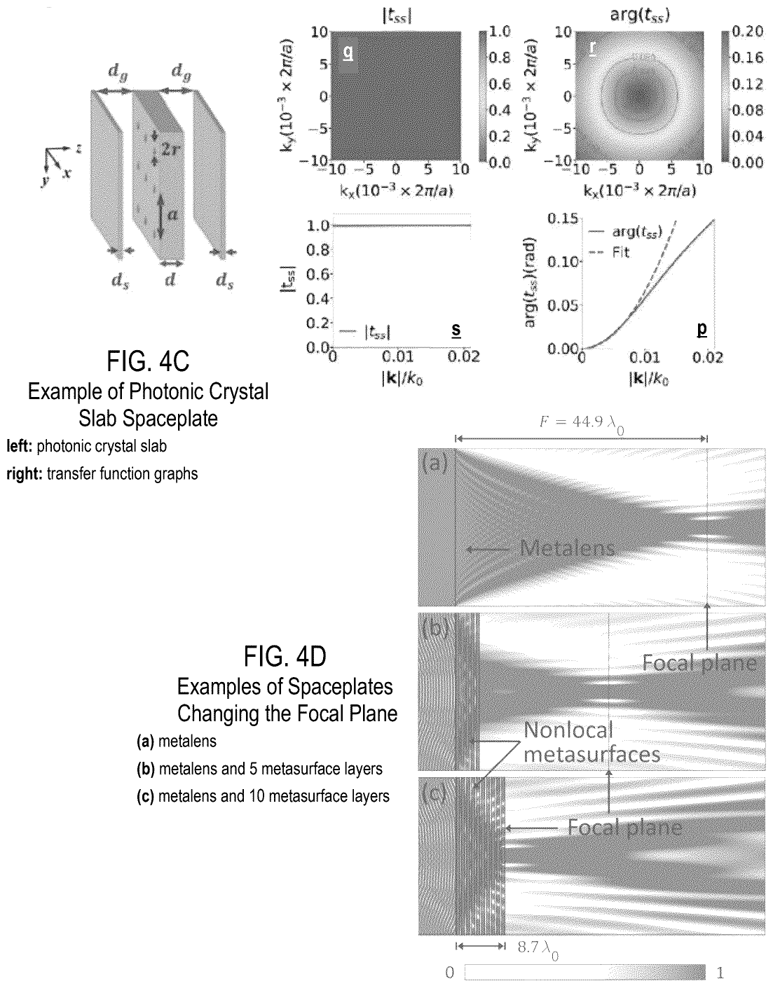

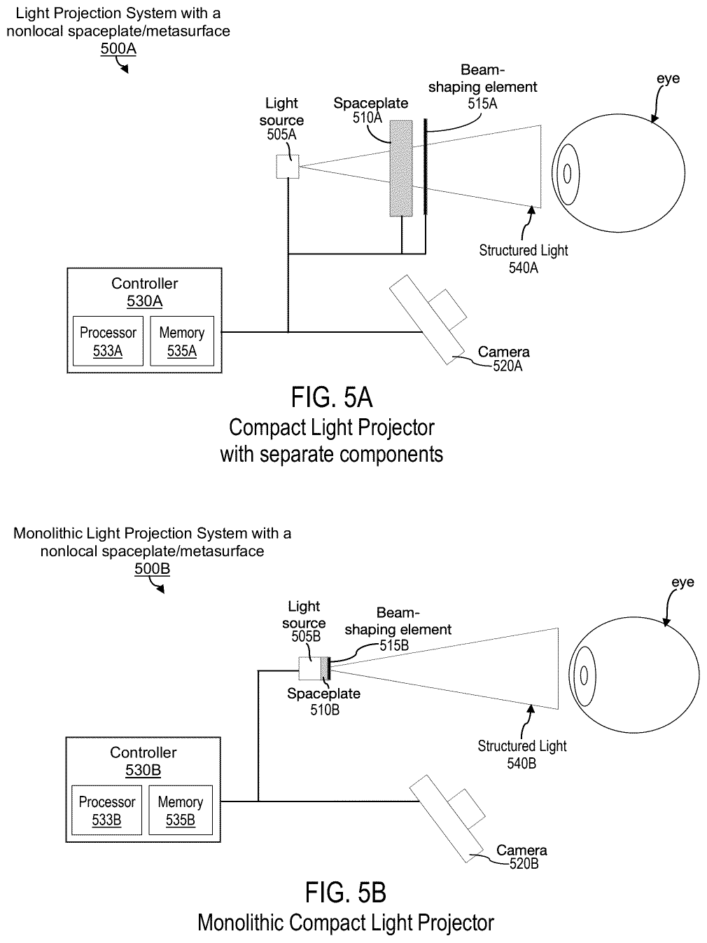

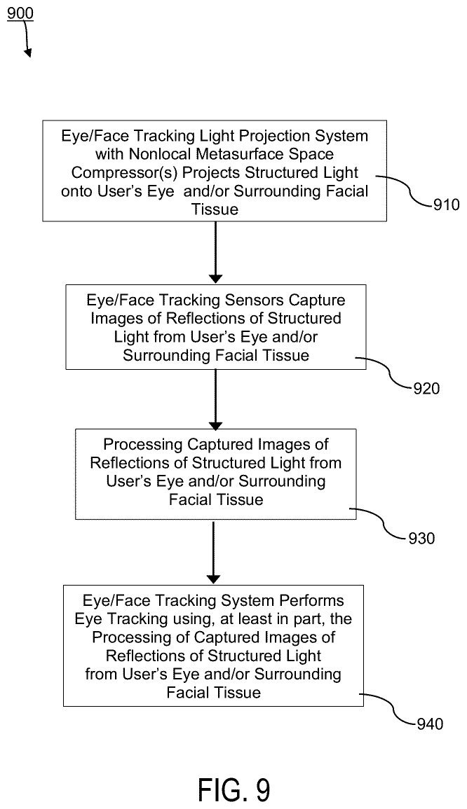

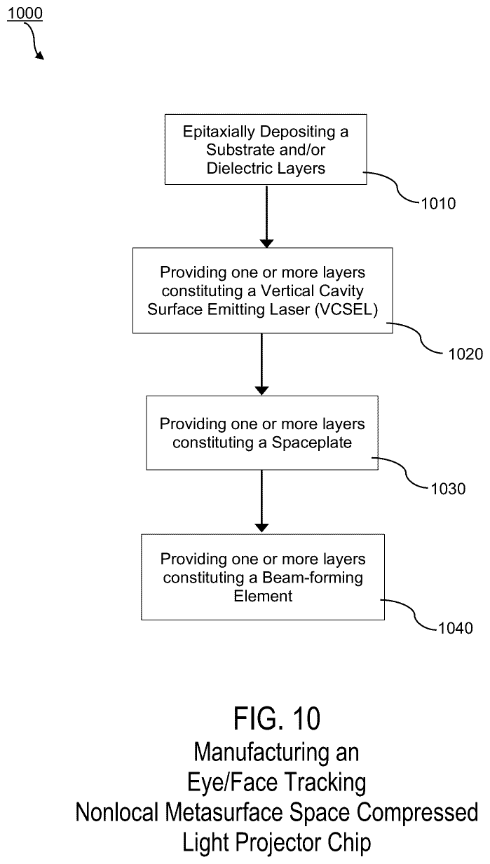

The following disclosure is broken down into 2 main sections:
I. Near-Eye Device(s), describing near-eye devices which may be employed with examples of the present disclosure, with reference to FIGS. 1-3B; and
II. Compact Light Projection with One or More Nonlocal Metasurface Space Compressors, describing nonlocal metasurface space compressors: nonlocal flat optics (the theory), spaceplates, and multilayer metasurfaces, with reference to FIGS. 4A-4D; non-limiting examples of compact light projectors for eye and/or face tracking using nonlocal metasurface space compressors, with reference to FIGS. 5A-8; a non-limiting example of a method of eye and or face tracking, with reference to FIG. 9; and a non-limiting example of a method of manufacturing, with reference to FIG. 10.

### I. Near-Eye Device(S)

FIG. 1 illustrates a block diagram of a near-eye display device which may be part of a display system environment, according to an example. As mentioned above, a “near-eye display device” may refer to a device in close proximity to a user's eye which is capable of some sort of display to one or both of the user's eyes, including a wearable headset, such as, e.g., a head-mounted display (HMD) device, and/or other wearable eyewear, such as, e.g., “smartglasses.” The display environment may include an artificial reality environment, where “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display device.”

While this section describes near-eye display devices, examples of the present disclosure are not limited thereto. Examples of the present disclosure are expressly intended to apply to other wearable devices besides the near-eye display devices described herein, including near-eye devices which may have, e.g., Internet of Things (IoT) and/or other audio/visual capabilities, such as, for example, the Ray-Ban™|Meta™ line of smartglasses.

As shown in FIG. 1, an artificial reality system environment 100 may include a near-eye display device 120 and an optional input/output interface 140, each of which may be coupled to an optional console 110. The artificial reality system environment 100 may also include an optional external imaging device (not shown), as discussed in relation to locators 126 below. As would be understood by one of ordinary skill in the art, FIG. 1 is a schematic diagram, and is not indicative of size, location, orientation, and/or relative sizes/locations/orientations of any of the systems, components, and/or connections shown therein. For example, a figurative “bus” connects some, but not all, of the components shown inside the near-eye display device 120 in FIG. 1; however, all of the components therein may be connected by the same bus and/or busses, or may have direct and/or indirect connections with, e.g., the processor(s) 121. Such electrical, control, and/or power connections may be implemented in a large variety of ways, as would be understood by one of ordinary skill in the art.

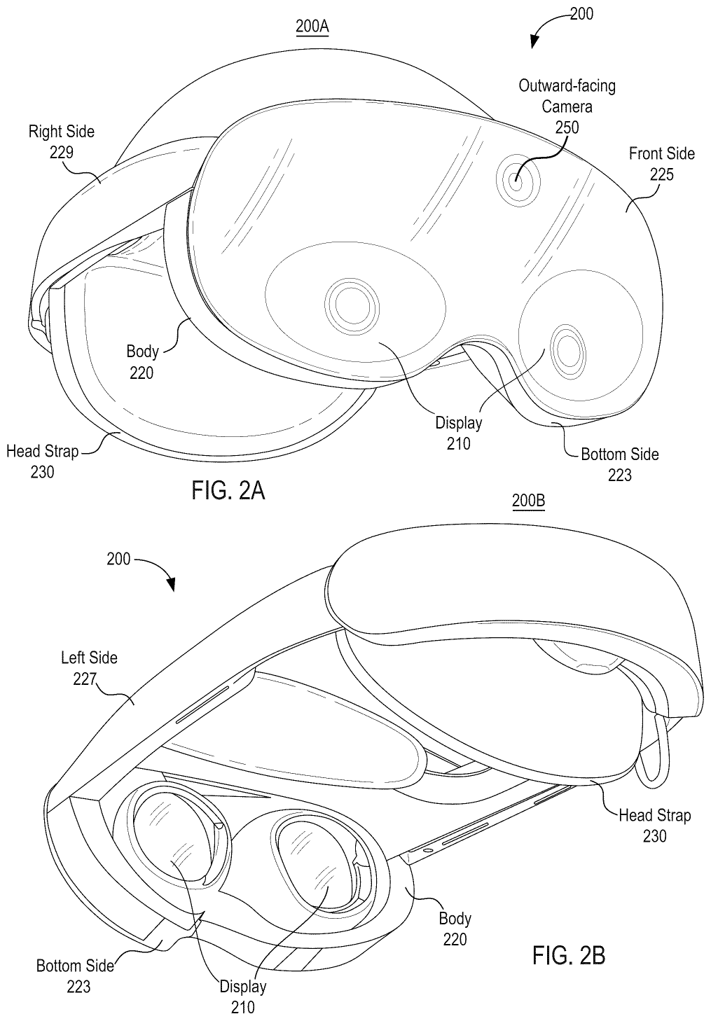

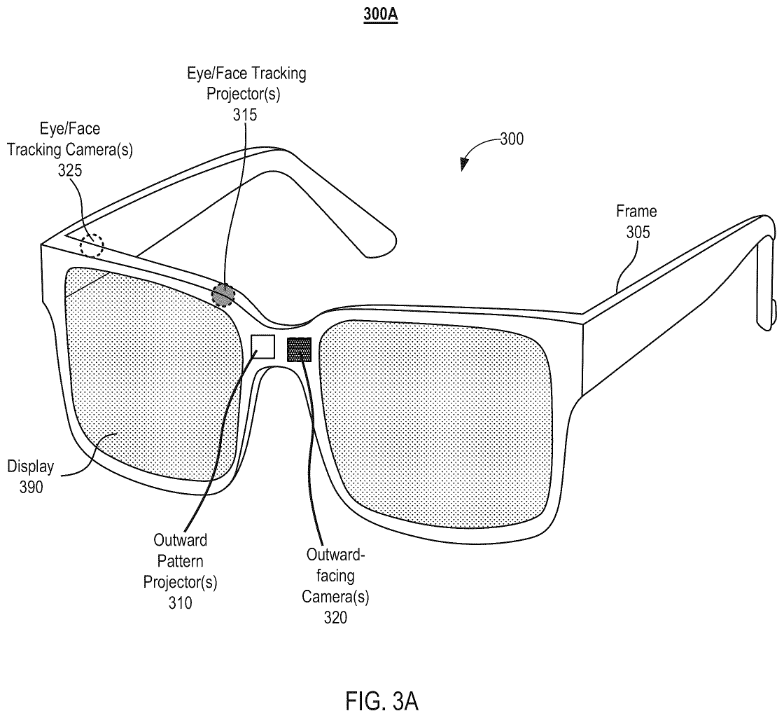

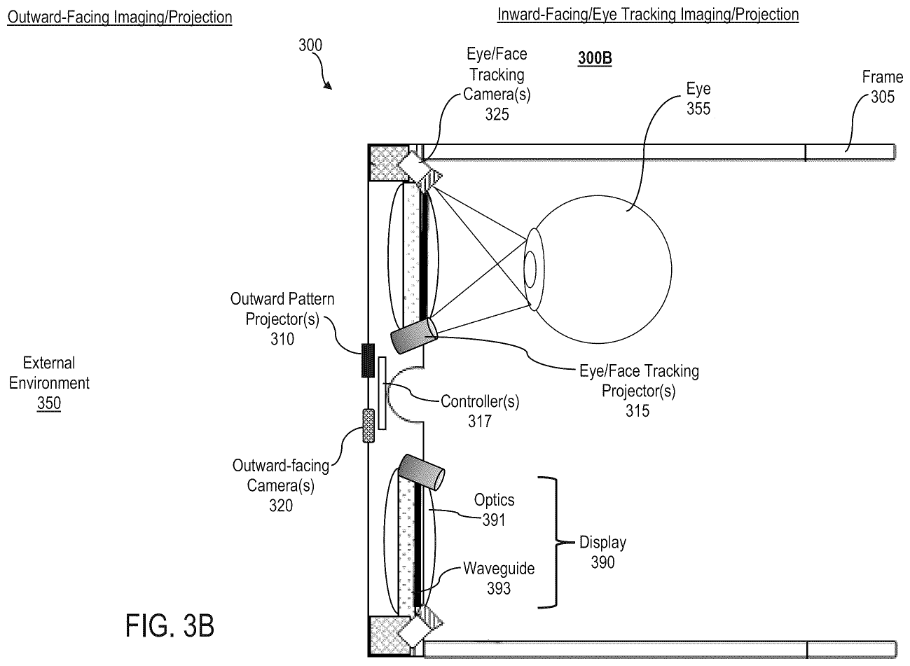

The optional console 110 may be optional in some instances where functions of the optional console 110 may be integrated into the near-eye display device 120. In some examples, the near-eye display device 120 may be implemented in any suitable form-factor, including a head-mounted display (HMD), a pair of glasses, or other similar wearable eyewear or device. In some examples, the near-eye display device 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other. Some non-limiting specific examples of implementations of the near-eye display device 120 are described further below with respect to FIGS. 2A-2B and 3A-3B.

In some examples, the near-eye display device 120 may present content to a user, including, for example, audio/visual content, such as, e.g., virtual reality (VR), augmented reality (AR), and/or mixed reality (MR) content. In augmented reality (AR) and/or mixed reality (MR) examples, the near-eye display device 120 may combine images (and/or a see-through view) of a physical, real-world environment external to the near-eye display device 120 and artificial reality/digital content (e.g., computer-generated images, video, sound, etc.) to present an augmented reality (AR) or mixed reality (MR) environment for the user.

As shown in FIG. 1, the near-eye display device 120 may include any one or more of one or more processor(s) 121, display electronics 122, one or more outward-facing camera(s) 123, display optics 124, one or more locators 126, one or more position sensors 128, an eye/face tracking unit 130, an inertial measurement unit (IMU) 132, a wireless communication sub-system 134, one or more outward projectors 172, and/or one or more inward projectors 173. In some examples, the near-eye display device 120 may include additional components; in other examples, the near-eye display device 120 may omit any one or more of the one or more locators 126, the one or more position sensors 128, the eye/face tracking unit 130, the inertial measurement unit (IMU) 132, the wireless communication sub-system 134, the one or more outward projectors 172, and/or the one or more inward projectors 173. As would be understood by one of ordinary skill in the art, various operational, electronic, communication (for, e.g., control signals), electrical and other such connections may or may not also be included between and among the components of the near-eye display device 120.

In some examples, the display electronics 122 may display or facilitate the display of images to the user according to data received from control electronics disposed in, for example, the near-eye display device 120, the optional console 110, the input/output interface 140, and/or a system connected by wireless or wired connection with the near-eye display device 120. In some examples, such electronics may include a virtual reality engine, such as, for example, the virtual reality engine 116 in the external console 110 described below, a virtual reality engine implemented, in part or in whole, in electronics in the near-eye display device 120, and/or a virtual reality engine implemented, in whole or in part, in an external system connected by the wireless communication subsystem 134, etc. In some examples, the display electronics 122 may include one or more display panels, and may include and/or be operationally connected to the display optics 124. In some examples, the display electronics may include one or more of a liquid crystal display (LCD) and/or a light-emitting diode (LED) and may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display electronics 122 may include and/or be operationally connected to the one or more outward projectors 172 and/or the one or more inward projectors 173; in some examples, the eye/face tracking unit 130 may also include and/or be operationally connected to the one or more inward projectors 173. As indicated by the striped lined box in FIG. 1, there may be operational and/or other connections between and among the display electronics 122, the eye/face tracking unit 130, the one or more outward projectors 172, and/or the one or more inward projectors 173. As indicated above, such connections may also be included between and among these and other components of the near-eye display device 120; the possible connections indicated by the striped lined box in FIG. 1 are shown herein as they are germane to examples of the present disclosure.

In some examples, the one or more inward projectors 173 may, under the control of the display electronics 122, form an image in angular domain for direct observation by a viewer's eye through a pupil. In some examples, the same or different one or more inward projectors 173 may, under the control of the eye/face tracking unit 130, project a fringe or other pattern on the eye (such as the inward projectors 310 of FIGS. 3A and 3B discussed below). As used herein, “eye/face tracking” may refer to determining an eye's position or relative position, including orientation, location, and/or gaze of a user's eye, as well as determining facial characteristics and parameters, such as from the flesh covering the orbital socket, the eyelids, eyebrows, and/or any other regions around the eye or optionally elsewhere on the face. In examples where at least some of the one or more inward projectors 173 may be used to project a fringe pattern on the eye and/or face, reflections from the projected pattern on the eye may be captured by a camera and analyzed (e.g., by the eye/face tracking unit 130 and/or the eye/face tracking module 118 in the optional console 110) to determine a position of the eye (the pupil), a gaze, etc., and/or characteristics of one or more portions of the face (including the region immediately adjacent to the eye). In other examples, the eye/face tracking unit 130 may capture reflected radio waves emitted by a miniature radar unit. These data associated with the eye and/or face may be used to determine or predict eye position, orientation, movement, location, gaze, etc., and/or characteristics of one or more portions of the face (including the region immediately adjacent to the eye).

In some examples, the one or more outward projectors 172 may, under the control of the display electronics 122, project a fringe or other pattern on the external environment (such as the outward projectors 315 of FIGS. 3A and 3B). In examples where at least some of the one or more outward projectors 172 may be used to project a fringe pattern on the external environment, reflections from the projected pattern on the external environment may be captured by a camera and analyzed to determine a position of objects in the external environment, distances between the user and objects and/or surfaces of the external environment, etc.

In some examples, a location of any of the one or more inward projectors 173 and/or the one or more outward projectors 172 may be adjusted to enable any number of design modifications. For example, in some instances, the one or more inward projectors 173 may be disposed in the near-eye display device 120 in front of the user's eye (e.g., “front-mounted” placement). In a front-mounted placement, in some examples, the one or more inward projectors 173 under control of the display electronics 122 may be located away from a user's eyes (e.g., “world-side”). In some examples, the near-eye display device 120 may utilize a front-mounted placement to propagate light and project an image on the user's eye(s).

In some examples, the one or more outward and/or inward projectors 172 and/or 173 may employ a controllable light source (e.g., a laser) and a micro-electromechanical system (MEMS) beam scanner to create a light field from, for example, a collimated light beam. In some examples, the light source of the one or more projectors 172 and/or 173 may include one or more of a liquid crystal display (LCD), a light emitting diode (LED) or micro-light emitting diode (mLED), an organic light emitting diode (OLED), an inorganic light emitting diode (ILED), an active-matrix organic light emitting diode (AMOLED), a transparent organic light emitting diode (TLED), any other suitable light source, and/or any combination thereof. In some examples, the one or more projectors may comprise a single electronic display or multiple electronic displays (e.g., one for each eye of the user).

In some examples, the display optics 124 may project, direct, and/or otherwise display image content optically and/or magnify image light received from the one or more inward projectors 173 (and/or otherwise created by the display electronics 122), correct optical errors associated with image light created and/or received from the external environment, and/or present the (corrected) image light to a user of the near-eye display device 120. In some examples, the display optics 124 may include an optical element or any number of combinations of various optical elements as well as mechanical couplings to, for example, maintain relative spacing and orientation of the optical elements in the combination. In some examples, one or more optical elements in the display optics 124 may include an aperture, a Fresnel lens, a refractive lens, a reflective mirror, a diffractive element, a waveguide, a filter, or any other optical element suitable for affecting and/or otherwise manipulating light emitted from the one or more inward projectors 173 (and/or otherwise created by the display electronics 122). In some examples, one or more optical elements in the display optics 124 may have an optical coating, such as an anti-reflective coating, a reflective coating, a filtering coating, and/or a combination of different optical coatings.

In some examples, the display optics 124 may be used to combine the view of an environment external to the near-eye display device 120 and artificial reality content (e.g., computer-generated images) generated by, e.g., the virtual reality engine 116 in the console 110, and projected by, e.g., the one or more inward projectors 173 (and/or otherwise created by the display electronics 122). In such examples, the display optics 124 may augment images of a physical, real-world environment external to the near-eye display device 120 with generated and/or overlaid digital content (e.g., images, video, sound, etc.) projected by the one or more inward projectors 173 (and/or otherwise created by the display electronics 122) to present an augmented reality (AR) to a user.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display device 120. In some examples, the optional console 110 may identify the one or more locators 126 in images captured by an optional external imaging device to determine the artificial reality headset's position, orientation, or both. The one or more locators 126 may each be a light-emitting diode (LED), a corner cube reflector, a reflective marker, a type of light source that contrasts with an environment in which the near-eye display device 120 operates, or any combination thereof.

In some examples, the optional external imaging device (not shown) may include one or more cameras, one or more video cameras, any other device capable of capturing images including the one or more locators 126, or any combination thereof. The optional external imaging device may detect light emitted or reflected from the one or more locators 126 in a field of view of the optional external imaging device.

In some examples, the one or more position sensors 128 may sense motion of the near-eye display device 120 and, in response, generate one or more measurement signals and/or data. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display device 120. Estimated positions may be of a reference point on the near-eye display device 120, and estimated positions may be, for example, relative to an initial position of the near-eye display device 120, relative to other objects in an external environment, relative to virtual objects in an artificial environment or augmented/mixed reality, etc., as would be understood by one of ordinary skill in the art. For example, the inertial measurement unit (IMU) 132 may integrate measurement signals received from accelerometers over time to estimate a velocity vector and integrate the velocity vector over time to determine an estimated position of the near-eye display device 120. Alternatively, the inertial measurement unit (IMU) 132 may provide the sampled measurement signals to the optional console 110, which may determine the fast calibration data.

In some examples, the wireless communication subsystem 134 may include an ultra-wide band (UWB) transceiver. Ultra-wide band (UWB) wireless communication technology is used for short-range, fast, and secure data transmission environments. Ultra-wide band (UWB) wireless communication technology provides high transmission speed, low power consumption, and large bandwidth, in addition to the ability to co-exist with other wireless transmission technologies. The ultra-wide band (UWB) transceiver may be used to detect another user (head-mounted display (HMD) device) within range of communication and within an angle-of-arrival (AoA), then establish line-of-sight (LoS) communication between the two users. The communication may be in audio mode only or in audio/video mode. In other examples, the ultra-wide band (UWB) transceiver may be used to detect the other user, but a different communication technology (transceiver) such as WiFi or Bluetooth Low Energy (BLE) may be used to facilitate the line-of-sight (LoS) communication. In some cases, multiple wireless communication transceivers may be available and one with lowest power consumption, highest communication quality (e.g., based on interfering signals), or user choice may be used. For example, the communication technology may be selected based on a lowest power consumption for a given range.

In some examples, the one or more processors 121 may be the control electronics (which may include, e.g., an operating system) for the near-eye display device 120. The one or more processors 121 may be employed for controlling one or more of the display electronics 122, the display optics 124, the one or more locators 126, the one or more position sensors 128, the eye/face tracking unit 130, the inertial measurement unit (IMU) 132, the wireless communication sub-system 134, the one or more outward projectors 172, and/or the one or more inward projectors 173, according to the present disclosure. The one or more processors 121 may be implemented, in whole or in part, as a separate physical component in the near-eye display device 120, as distributed among and/or integrated into one or more components of the near-eye display device 120 (such as, e.g., the display electronics 122), and/or externally to near-eye display device 120, such as being implemented/integrated in, for example, the input/output interface 140 and/or the console 110 (e.g., the eye/face tracking module 118, the headset tracking module 114, the virtual reality engine 116, the application store 112, etc.), and/or in another external system connected by, for example, the wireless communication subsystem 134. In some examples, the one or more processors 121 of the near-eye display device 120 may receive input, store, and process data, and/or control the components of the near-eye display device 120 in accordance with received input and/or stored/processed data in order to maintain optimal operating conditions of one or more components in the near-eye display device 120.

In some examples, the one or more processors 121, any control electronics, and/or any of the other components of the near-eye display device 120 may be implemented in and/or by any number of processors executing instructions stored on any number of non-transitory computer-readable storage media (not shown) disposed on/in and/or communicatively linked to the near-eye display device 120. The one or more processors 121 may include multiple processing units executing instructions in parallel. The non-transitory computer-readable storage medium/media may be any memory, such as a hard disk drive, a removable memory, or a solid-state drive (e.g., flash memory or dynamic random access memory (DRAM)). In some examples, the one or more processors 121 in the near-eye display device 120 may perform one or more functions; in some examples, one or more non-transitory computer-readable storage media in the near-eye display device 120 may store instructions that, when executed by the one or more processors 121, cause the one or more processors 121 to perform any of the functions described herein and/or to control any of the components described herein. In some examples, functions such as those described below in reference to the optional console 110 (e.g., eye/face tracking, headset tracking, and the generation of virtual reality images) may be performed by the one or more processors 121 integrated with and/or wired/wirelessly connected to the near-eye display device 120.

In some examples, the input/output interface 140 may be a device that allows a user to send action requests to the optional console 110 and/or the near-eye display device 120. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110 and/or the near-eye display device 120, either or both of which may perform an action corresponding to the requested action.

In some examples, the optional console 110 may provide content to the near-eye display device 120 for presentation to the user in accordance with information received from one or more of the near-eye display device 120, the input/output interface 140, and/or the external imaging device 150. For example, as shown in the example of FIG. 1, the optional console 110 may include an application store 112, a headset tracking module 114, a virtual reality engine 116, and an eye/face tracking module 118. In some examples, the optional console 110 may include different or additional modules than those described herein, and the functions described further below may be distributed among the components of the optional console 110 in a different manner than is described here (or may be distributed, in part or whole, in one or more components in the near-eye display device 120). It should be appreciated that the optional console 110 may or may not be needed, or the optional console 110 may be integrated, in whole or in part, with the input/output interface 140 and/or the near-eye display device 120, or the optional console 110 may be separate from the input/output interface 140 and/or the near-eye display device 120. In some examples, the optional console 110 may include a processor and a non-transitory computer-readable storage medium storing instructions executable by the processor (including, for example, the application store 112).

In some examples, the application store 112 may store one or more applications for execution by one or more processors in at least one of the optional console 110, the near-eye display device 120, the input/output interface 140, and/or the optional external imaging device 150. An application may include a group of instructions that, when executed by a processor, generates content for presentation to the user. Examples of the applications may include gaming applications, conferencing applications, video playback application, or other suitable applications.

In some examples, the virtual reality engine 116 may execute applications within the artificial reality system environment 100 and receive position/acceleration/velocity information of the near-eye display device 120, predicted future positions of the near-eye display device 120, or any combination thereof from the headset tracking module 114. In some examples, the virtual reality engine 116 may also receive estimated eye position and orientation information from the eye/face tracking module 118. Based on the received information, the virtual reality engine 116 may determine content including, e.g., virtual reality images, to provide to the near-eye display device 120 for presentation to the user.

In some examples, the eye/face tracking module 118, which may be implemented as a processor, may receive eye/face tracking data from the eye/face tracking unit 130 and determine, for example, the position of the user's eye based on the eye/face tracking data. In some examples, the position of the eye may include an eye's orientation, location, or both relative to the near-eye display device 120 or any element thereof. Accordingly, in these examples, because the eye's axes of rotation change as a function of the eye's location in its socket, determining the eye's location in its socket may allow the eye/face tracking module 118 to more accurately determine the eye's orientation.

Generally speaking, any one or more components shown in FIG. 1 may be further broken down into sub-components and/or combined together to form larger modules, as would be understood by one of ordinary skill in the art. For example, in some examples, the near-eye display device 120 may include additional, fewer, and/or different components than shown and/or described in reference to FIG. 1. Moreover, groupings of components may work together as sub-systems within the near-eye display device 120, and/or share/provide/transmit data and/or control information, etc., as would be understood by one of ordinary skill in the art. For example, as indicated by the dotted line box connecting/overlapping the display electronics 122, the one or more outward-facing camera(s) 123, the one or more outward projectors 172, the one or more inward projectors 173, and the eye/face tracking unit 130 in FIG. 1, these listed components may work together and/or may be somewhat integrated in terms of form and/or function in actual implementations of the near-eye display device 120 in FIG. 1.

Generally speaking, any one or more of the components and/or functionalities described in reference to any of the drawings/figures herein may be implemented by hardware, software, and/or any combination thereof, according to examples of the present disclosure. In some examples, the components and/or functionalities may be implemented by at least one of any type of application, program, library, script, task, service, process, or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

FIGS. 2A and 2B illustrate a front prospective view and a back prospective view, respectively, of a near-eye display device in the form of a head-mounted display (HMD) device 200 which may be implemented with an inward-facing and/or an outward-facing projection system to which examples of the present disclosure may be applied. In some examples, the head-mounted display (HMD) device 200 may be a specific implementation of the near-eye display 120 of FIG. 1, and may be configured to operate as a virtual reality (VR) system, an augmented reality (AR) system, a mixed reality (MR) system, and/or as part of any such system that uses displays or wearables, or any combination thereof. In some examples, the head-mounted display (HMD) device 200 may include a display 210, a body 220 and a head strap 230. In some examples, the head-mounted display (HMD) device 200 may include additional, fewer, and/or different components than shown and/or described in reference to FIGS. 2A-2B.

FIG. 2A is a frontal prospective view 200A showing a front side 225, a bottom side 223, and a right side 229 of the body 220, as well as the display 210, an outward-facing camera 250, and the head strap 230 of the head-mounted display (HMD) device 200. FIG. 2B is a bottom rear prospective view 200B showing the bottom side 223, the front side 225, and a left side 227 of the body 220, as well as the display 210 and the head strap 230 of the head-mounted display (HMD) device 200. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes.

In some examples, the head-mounted display (HMD) device 200 (including, e.g., the display 210) in FIGS. 2A-2B may include any number of processors, display electronics, and/or display optics similar to the one or more processors 121, the display electronics 122, and the display optics 124 described in reference to FIG. 1. For example, in some examples, the outward-facing camera 150 may correspond to the out-facing camera(s) 123 of the near-eye display device 120, and may be under the control of processor(s) 121, of FIG. 1, and/or be operationally connected to any one or more of the display electronics 122, the one or more outward projectors 172, the one or more inward projectors 173, and the eye/face tracking unit 130 as indicated by the dotted line box connecting/overlapping those components in FIG. 1.

In some examples, the display electronics and display optics of the head-mounted display (HMD) device 200 may display and/or facilitate the display of media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the display electronics may display a three-dimensional (3D) image, e.g., using stereoscopic effects produced by two-dimensional panels, to create a subjective perception of image depth. In some examples, the display optics in the head-mounted display (HMD) device 200 may include a single optical element or any number of combinations of various optical elements, such as waveguides, gratings, optical lenses, optical couplers, mirrors, etc., as well as mechanical couplings to maintain relative spacing and orientation of the optical elements in the combination, such as are described above in reference to the display optics 124 in FIG. 1.

In some examples, the head-mounted display (HMD) device 200 in FIGS. 2A-2B may include to the outward-facing camera 250, which may be similar to the out-facing camera(s) 123 in FIG. 1, and may operate similarly to the outward-facing camera(s) 320 in FIGS. 3A-3B, as discussed and described below. In some examples, the head-mounted display (HMD) device 200 in FIGS. 2A-2B may include one or more additional outward-facing cameras in addition to the outward-facing camera 250, such as the multiple outward-facing cameras employed in the Quest 3™ from Meta™.

In some examples, the head-mounted display (HMD) device 200 in FIGS. 2A-2B may include one or more inward/outward projectors, similar to the one or more inward projectors 173 and/or one or more outward projectors 172 of FIG. 1. In some examples, the one or more inward projectors of the head-mounted display (HMD) device 200 may project an image for direct observation by the user's eye and/or project a fringe or other pattern on the eye. In some examples, the one or more outward projectors of the head-mounted display (HMD) device 200 may project a fringe or other pattern on the external environment and/or objects/surfaces within the external environment in order to, for example, perform 3-dimensional (3D) mapping of the external environment. In some examples, the one or more inward/outward projectors of the head-mounted display (HMD) device 200 may include one or more of a liquid crystal display (LCD) and/or a light-emitting diode (LED); more specifically, the one or more inward/outward projectors of the head-mounted display (HMD) device 200 may include, e.g., one or more of a liquid crystal display (LCD), a light emitting diode (LED) or micro-light emitting diode (mLED), an organic light emitting diode (OLED), an inorganic light emitting diode (ILED), an active-matrix organic light emitting diode (AMOLED), a transparent organic light emitting diode (TLED), any other suitable light source, and/or any combination thereof. It should be appreciated that in some examples, the inward projectors of the head-mounted display (HMD) device 200 may be placed near and/or closer to a user's eye (e.g., “eye-side”). It should be appreciated that, in some instances, utilizing a back-mounted inward projector may help to reduce size or bulkiness of any required housing required for a display system, which may also result in a significant improvement in user experience for a user.

In some examples, the head-mounted display (HMD) device 200 may also include an eye/face tracking system, one or more locators, one or more position sensors, and an inertial measurement unit (IMU), similar to the eye/face tracking unit 130, the one or more locators 126, the one or more position sensors 128, and the inertial measurement unit (IMU) 132, respectively, described in reference to FIG. 1. In some examples, the head-mounted display (HMD) device 100 may include various other sensors, such as depth sensors, motion sensors, image sensors, light sensors, and/or the like. Some of these sensors may sense any number of structured or unstructured light patterns projected by the one or more inward/outward projectors of the head-mounted display (HMD) device 200 for any number of purposes, including, e.g., sensing, eye/face tracking, and/or the creation of virtual reality (VR) content.

In some examples, the head-mounted display (HMD) device 200 may include and/or be operably connected to a virtual reality engine (not shown), similar to the virtual reality engine 116 described in reference to FIG. 1, that may execute applications within the head-mounted display (HMD) device 200 and receive depth information, position information, acceleration information, velocity information, predicted future positions, or any combination thereof of the head-mounted display (HMD) device 200 from the various sensors. In some examples, the information received by the virtual reality engine may be used for producing a signal (e.g., display instructions) to the one or more display assemblies. In some examples, the head-mounted display (HMD) device 200 may include locators (not shown), similar to the one or more locators 126 described in reference to FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

As stated above, the head-mounted display (HMD) device 200 may include additional, fewer, and/or different components than shown and/or described in reference to FIGS. 2A-2B. In some examples, the head-mounted display (HMD) device 200 may include an input/output interface (similar to the input/output interface 140 in FIG. 1), a console (similar to the console 110 described in reference to FIG. 1), and/or a camera to capture images or videos of the user's environment to present the user with, e.g., augmented reality (AR)/virtual reality (VR) content. In some examples, the head-mounted display (HMD) device 200 may include one or more cameras to capture reflections of patterns projected by the one or more inward/outward projectors.

FIGS. 3A and 3B illustrate a perspective view 300A and a top view 300B, respectively, of a near-eye display device 300 in the form of a pair of glasses having both an inward-facing and an outward-facing projection systems to which examples of the present disclosure may be applied. In some examples, the near-eye display device 300 may be a specific implementation of the near-eye display device 120 of FIG. 1, and may be configured to operate as a virtual reality (VR) system, an augmented reality (AR) system, a mixed reality (MR) system, and/or as part of any such system that uses displays or wearables, or any combination thereof. As shown in FIGS. 3A-3B, the near-eye display device 300 may include a frame 305, one or more outward pattern projectors 310, one or more eye/face tracking projectors 315 (which effectively operate as inward pattern projectors), an outward-facing camera(s) 320, an eye/face tracking camera(s) 325, and a display 390.

As shown in FIGS. 3A-3B, the near-eye display device 300 may include an inward-facing imaging/projection system, comprising the one or more eye/face tracking projectors 315 (i.e., inward pattern projectors) and the eye/face tracking camera(s) 325, and an outward-facing imaging/projection system, comprising the one or more outward pattern projectors 310 and the outward-facing camera(s) 320. In some examples, the inward-facing imaging/projection system of the near-eye display device 300 may be an eye/face tracking system, where the one or more eye/face tracking projectors 315 project a pattern directly on the user's eye(s) and the eye/face tracking camera(s) 325 captures one or more reflections of the projected pattern on the user's eye(s), and the eye/face tracking system uses the captured reflections to track the user's eye(s). In some examples, the one or more eye/face tracking projectors 315 may be disposed on the temple arms of the frame 305 of the near-eye display device 300, and may project one or more patterns on eye lens of the near-eye display device 300, which reflects those one or more patterns onto the user's eye 355. In some examples, the inner surface of the eye lens may be coated with a reflective surface, fabricated with a reflective surface, and/or covered by a metasurface or other type of nanostructure which may be suitably employed for the re-direction of the light projected by the one or more eye/face tracking projectors 315, as would be understood by one of ordinary skill in the art. In such examples, the inner surface may create the one or more patterns which are projected onto the user's eye 355, either alone or in combination with the one or more eye/face tracking projectors 315. In other words, in some examples, the one or more eye/face tracking projectors 315 may project unstructured light and the inner surface re-directed the light onto the user's eye and/or face may provide the one or more patterns which may be used for eye/face tracking. In some examples, the eye/face tracking camera(s) 325 may be a single photon avalanche diode (SPAD) sensor. In some examples, the one or more eye/face tracking projectors 315 may project a pattern such as, for example, a structured image (e.g., a fringe pattern) projected onto the eye and/or face by a micro-electromechanical system (MEMS) based scanner reflecting light from a light source (e.g., a laser).

As shown in FIG. 3B, in some examples, the outward-facing imaging/projection system of the near-eye display device 300 may include the one or more outward pattern projectors 310, which project a pattern directly on an external environment 350 and/or one or more objects/surfaces in the external environment 350, and the outward-facing camera(s) 320, which captures one or more reflections of the projected pattern on the one or more objects/surfaces or all or part of the entire external environment 350. In some examples, such an outward-facing imaging/projection system may serve a variety of purposes, including, but not limited to, profilometry, determining surface patterns/structures of objects in the external environment 350, determining distances from the user to one or more objects/surfaces in the external environment 350, determining relative positions of one or more objects/surfaces to each other in the external environment 350, determining relative velocities of one or more objects/surfaces in the external environment 350, etc., as would be understood by one of ordinary skill in the art. In some examples, the outward-facing imaging/projection system of the near-eye display device 300 may also be employed to capture images of the external environment 350. In such examples, the captured images may be processed, for example, by a virtual reality engine to add virtual objects to the captured images or modify physical objects in the captured images, and the processed images may be displayed to the user by the display 390 for augmented reality (AR) and/or mixed reality (MR) applications.

In some examples, the display 390 may include, in whole or in part, one or more processors, display electronics, and/or display optics similar to the one or more processors 121, the display electronics 122, and the display optics 124 in FIG. 1, and may be configured to present media or other content to a user, including, e.g., virtual reality (VR), augmented reality (AR) system, and/or mixed reality (MR) content. In some examples, the display 390 may include any number of light sources, such as, e.g., a liquid crystal display (LCD) display panel, a light-emitting diode (LED) display panel, or an optical display panel (e.g., a waveguide display assembly), etc., and any number of optical components, such as waveguides, gratings, lenses, mirrors, etc., as would be understood by one of ordinary skill in the art.

As shown in FIG. 3B, in some examples, the display 390 of the near-eye display device 300 may include optics 391 and a waveguide 393, which may be coupled to a projector (such as, e.g., the one or more inward projectors 173 of FIG. 1). In some examples, the display 390 may combine the view of the external environment 350 and artificial reality content (e.g., computer-generated images). In some examples, light from the external environment 350 may traverse a “see-through” region of the waveguide 393 in the display 390 to reach a user's eye 355 (located somewhere within an eye box), while images are also projected for the user to see as part of an augmented reality (AR) display and/or a mixed reality (MR) display.

In such examples, the light of images projected by the projector may be coupled into a transparent substrate of the waveguide 393, propagate within the waveguide 393, be coupled with light from the user's actual environment, and be directed out of the waveguide 393 at one or more locations towards a user's eye 355 located within the eye box. In such examples, the waveguide 393 may be geometric, reflective, refractive, polarized, diffractive, and/or holographic, as would be understood of one of ordinary skill in the art, and may use any one or more of macro-optics, micro-optics, and/or nano optics (such as, e.g., metalenses and/or metasurfaces). In some examples, the optics 391 of the display 390 may include optical polymers, plastic, glass, transparent wafers (e.g., Silicon Carbide (SiC) wafers), amorphous silicon, Silicon Oxide (SiO₂), Silicon Nitride (SiN), Titanium Oxide (TiO), optical nylon, carbon-polymers, and/or any other transparent materials used for such a purpose, as would be understood by one of ordinary skill in the art.

In some examples, the near-eye display device 300 may further include various sensors on or within a frame 305, such as, e.g., any number of depth sensors, motion sensors, position sensors, inertial sensors, and/or ambient light sensors. In some examples, the various sensors may include any number of image sensors configured to generate image data representing different fields of views in one or more different directions (which may or may not include the outward-facing camera(s) 320). In some examples, the various sensors may be used as input devices to control or influence the displayed content of the near-eye display device 300, and/or to provide an interactive virtual reality (VR), augmented reality (AR), and/or mixed reality (MR) experience to a user of the near-eye display device 300. In some examples, the various sensors may also be used for stereoscopic imaging or other similar application.

In some examples, the near-eye display device 300 may further include one or more illuminators to project light into a physical environment (which may or may not include, e.g., the outward pattern projector(s) 310). The projected light may be associated with different frequency bands (e.g., visible light, infra-red light, ultra-violet light, etc.), and may serve various purposes. In some examples, the one or more illuminators may be used as locators, such as the one or more locators 126 described above with respect to FIG. 1. In such examples, the near-eye display device 300 may also include an image capture unit (which may or may not include the outward-facing camera(s) 320 and/or the external imaging device 150 of FIG. 1), which may capture images of the physical environment in the field of view. In some instances, the captured images may be processed, for example, by a virtual reality engine (such as, e.g., the virtual reality engine 116 of FIG. 1) to add virtual objects to the captured images or modify physical objects in the captured images, and the processed images may be displayed to the user by the display 390 for augmented reality (AR) and/or mixed reality (MR) applications.

In some examples, a majority of electronic components of the near-eye display device 300 in the form of a pair of glasses may be included in the frame 305 of the glasses (e.g., a top bar, a bridge, a rim, a lens, etc.). Examples of such electronic components included in the frame 305 include, but are not limited to, a camera, a sensor, a projector, a speaker, a battery, a microphone, and a battery management unit (BMU). In some examples, a battery management unit (BMU) may be an electronic system that may be used to manage charging and discharging of a battery (e.g., a lead acid battery). In some examples, the battery management unit (BMU) may, among other things, monitor a state of the battery, determine and report data associated with the battery, and provide environmental control(s) for the battery. In some examples, the temples 306 may be provided with a tapering profile, based on design considerations for the specific implementation. In such examples, the tapered temples may be utilized to house various electronic components. For example, in some cases, a microphone or speaker may often be placed towards a rear of a temple arm, near a user's ear, and as such, in many cases, a battery may be more likely to be placed near a front of the temple arm.

In FIG. 3B, an eye/face tracking system (such as that described in reference to eye/face tracking unit 130, the eye/face tracking module 118, and the inward projector(s) 173 of FIG. 1) may be implemented by the eye/face tracking projector(s) 315, which project patterns and/or other suitable lighting for performing eye/face tracking upon the user's eye 355 and/or portions of the user's face, the eye/face tracking camera(s) 325, which receive reflections of the light of the eye/face tracking projector(s) 315 from the user's eye 355 and/or portions of the user's face, and a controller (or controllers) 317, which process the reflections received by the eye/face tracking camera(s) 325 to perform eye/face tracking. In some examples, the controller 317 may be similar to the one or more processor(s) 121 in FIG. 1 (and thus may perform a wide variety of functions for the near-eye display device 300), other processor(s) which perform several tasks, and/or a processor(s) dedicated to performing eye tracking and/or face tracking.

In some examples, the controller 317 for performing eye tracking and/or face tracking may be communicatively connected with a memory, which may be at least one non-transitory computer-readable storage medium storing instructions executable by the controller 317. The controller 317 may include multiple processing units, and those multiple processing units may further execute instructions in parallel. The at least one non-transitory computer-readable storage medium may be any memory, such as a hard disk drive, a removable memory, or a solid-state drive (e.g., flash memory or dynamic random access memory (DRAM)). In various examples, the controller 317 may be further subdivided into multiple devices (for example, the functions of the controller 317 may be separated among various components, such as a digital signal processing (DSP) chip for eye and/or face tracking analysis as well as a Central Processing Unit (CPU) for controlling, e.g., the eye/face tracking projector(s) 315).

II. Compact Light Projection with One or More Nonlocal Metasurface Space Compressors

As mentioned above, it may be desirable to reduce the size, location, power/energy, and other requirements of the eye/face tracking system in any near-eye display device. For instance, having a smaller form factor for the eye/face tracking system may be beneficial for any near-eye display device 100, such as, e.g., the head-mounted display (HMD) device 200 in FIGS. 2A-2B and/or the near-eye display device 300 in the form of a pair of glasses in FIGS. 3A-3B, to increase its overall efficiency, while also providing an optimal user experience (UX), as would be understood by one of ordinary skill in the art. As discussed herein, examples of the present disclosure may be employed in any near-eye devices, with or without display capabilities, and/or with or without Virtual Reality (VR), Augmented Reality (AR), and/or Mixed Reality (MR) display capabilities.

Typically, integrating light projection systems (for image projection on the user's retina or for face/eye illumination) may be difficult because the light sources and detectors are positioned closely to the user's face in a complex system which must maintain a compact form factor. Conventionally, this limits the design space for the system designers/architects, leading them to have to make undesirable compromises-particularly of relevance here, in terms of reducing the capabilities of the light source(s) (such as, e.g., the power/intensity of illumination, the size and shape of the area to be illuminated, the focal depth of any pattern/shaped illumination, etc.), reducing the sensitivity of the eye/face tracking system (such as, e.g., the capabilities of the sensors used, etc.), and reducing the capabilities of the entire near-eye device because of the overall complexity of the system(s).

In examples according to the present disclosure, one or more nonlocal metasurface space compressors may be employed to improve the performance and size of image projection and illumination systems in near-eye display devices, such as, e.g., near-eye virtual reality (VR), augmented reality (AR), and/or mixed reality (MR) display devices. The nonlocal metasurface space compressor may permit an increase in propagation distance without affecting other system parameters, such as the focal length of the interface lenses.

In some examples, a nonlocal metasurface space compressor, such as a spaceplate, a multilayer metasurface/metalens, and/or any other nonlocal flat optics, may reduce the size of the eye/face tracking light projection system in a near-eye device. Such a spaceplate or multilayer metasurface/metalens may be made from amorphous silicon and/or other silica (e.g., Silicon Dioxide (SiO₂), Silicon Nitride (SiN), etc.). In some examples, the nonlocal metasurface space compressor may be a “sandwich” of a waveguide between two different metasurface layers, or the nonlocal metasurface space compressor may include multiple layers of alternating waveguides and metasurfaces.

In some examples, a compact eye/face tracking light projector including a nonlocal metasurface space compressor may be both smaller than a typical eye/face tracking light projection system and also provide a wider beam of illumination than a typical eye/face tracking light projection system. In some examples, a compact eye/face tracking light projector having a nonlocal metasurface space compressor may be manufactured relatively simply and cheaply using lithography, depending on the type, construction, and specific implementation of the nonlocal metasurface space compressor.

In some examples, a nonlocal metasurface space compressor such as a spaceplate may be manufactured from multiple layers of stretched polymer and may also be employed as a heat conductor to dissipate the heat from the illumination source. In other examples, a nonlocal metasurface space compressor such as a polarization-sensitive spaceplate may be employed for extended focal depth and depth information encoding (with a polarization-sensitive camera).

### Nonlocal Metasurface Space Compressors: Nonlocal Flat Optics, Spaceplates & Multilayer Metasurfaces

Recently, increasing attention has been paid to nonlocal metasurfaces, which are not limited to a local position-dependent response. Instead, the response/output of such nonlocal metasurfaces at a certain point of the output plane may depend on the input field across a region of space.

In the context of the macroscopic electrodynamics of continuous media, a nonlocal response occurs naturally in many materials, in the form of a nonlocal input-output relation between the induced polarization density and the applied field, which physically originates from polarization or charge-density waves that propagate across the material, creating a polarization response in regions potentially quite far from where the incident field is applied. This effect is common, albeit weak, in natural materials such as conductors, and it can be significantly enhanced in artificial metamaterials, even if all constituent materials are local, through the engineered interaction between neighboring elements and/or by using meta-atoms with a multipolar or bi-anisotropic response. Similarly, in metasurfaces, formed by planar arrays of polarizable meta-atoms, an effective nonlocal response is always present, but it is usually weak and, until recently, was usually treated as an issue to mitigate, because a metasurface with non-negligible nonlocality would respond slightly differently depending on the specific spatial profile of the incident field. Conversely, the field of nonlocal flat optics seeks to boost and leverage this property, and the new degrees of freedom it affords, to enable new functionalities and overcome some of the limitations of conventional optics and local flat optics. See, e.g., Shastri & Monticone, Nonlocal Flat Optics, Nature Photonics, vol. 17, pp. 36-47 (22 Dec. 2022); https://doi.org/10.1038/s41566-022-01098-5 (hereinafter referred to as “Nonlocal Flat Optics”), which is hereby incorporated by reference in its entirety.

Nonlocal metasurfaces require very different design principles and methodologies compared with local devices. While standard metasurfaces, as well as most optical components, are based on transversely varying distributions of some geometrical or material parameters, purely nonlocal metasurfaces do not necessarily require a position-dependent response and, therefore, they can be transversely homogenous or periodic, whereas they are typically inhomogeneous in the longitudinal direction. Since natural materials only exhibit weak nonlocality, artificial effective nonlocality based on specific structures and arrays of elements may be implemented by a variety of physical mechanisms, materials, and structures to provide a strongly nonlocal momentum-dependent response in metasurface form. See, e.g., Nonlocal Flat Optics for a more extensive discussion. The new degrees of freedom afforded by nonlocal metasurfaces, constrained only by certain symmetries and physical principles, provide new opportunities for the field of flat optics. See id.

As one relevant example, flat optical components such as local metalenses can substitute and miniaturize conventional refractive optical elements in addition to providing greater design flexibility. However, even more drastic reductions in the form factor of free-space optical systems, and potentially the complete monolithic integration of all optical elements, may be possible if the free-space volumes between consecutive optical elements and solid-state detectors can also be reduced, or completely removed, without changing the optical performance and functionality of the system. Conceptually, this requires emulating the angle- and distant-dependent phase φ(kₜ) gained by a plane wave propagating a distance L_{eff} in free space, as shown by equation (1) below:

$$φ ( {k}_{t} ) = {L}_{eff} \sqrt{\frac{{ω}^{2}}{{c}_{0}^{2}} - {k}_{t}^{2}} \qquad Eq . ( 1 )$$

where kₜ is the transverse wavevector/momentum. Using a device with a smaller thickness L<L_{eff}, thereby effectively “compressing space” for light propagation by a factor of L_{eff}/L. Since the required phase response is inherently angle-dependent, nonlocal metasurfaces are well-suited to implement this optical function within a thin planar structure, realizing space-compression devices known as “spaceplates.” See Nonlocal Flat Optics, p. 10.

Spatial-frequency filtering platforms, such as, for example, photonic crystal slabs and multilayer structures may be used to realize such spaceplates, as shown by the examples in FIGS. 4A-4D, which are based on FIGS. 4A-4D of Nonlocal Flat Optics. Simply stated, spaceplates implement an angle-dependent response of a free space volume over a smaller length, effectively compressing space for light propagation.

As shown by the examples in FIGS. 4A-4D, a combination of metalenses and/or spaceplates may lead to drastic miniaturization, whereby any optical system, may be engineered to have high transmission amplitude and an angle-dependent transmission phase that matches the response of a longer length of free space, over the largest possible angular and frequency ranges. FIGS. 4B and 4D illustrate how a spaceplate may be implemented using multilayer thin films; whereas FIG. 4C illustrates how a spaceplate may be implemented by a photonic crystal slab. As shown in FIG. 4D, a spaceplate may cause the focus (and the entire field distribution) to move towards a (flat) lens, effectively decoupling the focal length of the lens from the actual distance at which focusing is achieved and, hence, the length of the optical system.

The left side of FIG. 4A illustrates how an optical lens of thickness d_{eff} (shown on top left) may be compressed into a spaceplate of thickness d (shown on the bottom left). Specifically on the top left of FIG. 4A, it may be seen that an incoming light beam (indicated by an arrow) incident on an optical lens at angle θ will emerge at that same angle and be transversely translated by the optical lens by length W, after having traversed the entire thickness d_{eff}. On the bottom left of FIG. 4A, it may be seen that an incoming light beam (indicated by an arrow) incident on a spaceplate at angle θ will emerge at that same angle and be transversely translated by the optical lens by length w, resulting in a lateral beam shift of Δx, just as it would be the far longer optical element on top, except the spaceplate is several magnitudes less thick than the optical lens.

The right side of FIG. 4A illustrates how a typical optical element focusses an incoming collimated beam at a point at a working distance away from the optical element corresponding to its focal length f (on the top right), while a spaceplate on the bottom shortens that distance by Δs to f while preserving the lens strength by keeping the emerging rays parallel to the original incident rays (on the bottom right). Accordingly, the spaceplate effectively propagates light for a longer length than the physical space it occupies. For more details, see also, e.g., Reshef et al., An optic to replace space and its application towards ultra-thin imaging systems, Nature Communications, vol. 12, 3512 (10 Jun. 2021); https://doi.org/10.1038/s41467-021-23358-8 (hereinafter referred to as “Reshef 2021”), which is hereby incorporated by reference in its entirety.

FIG. 4B shows two graphs and a block diagram illustrating a spaceplate implemented as a nonlocal metamaterial multilayer stack. More specifically, a spaceplate may include alternating layers of silicon and silica of various thicknesses, engineered to reproduce the Fourier transfer function H for propagation through a vacuum of light having an incident angle less than an angle θ=15° at an optical wavelength of λ=1550 nm. The graphic on the left of FIG. 4B plots the calculated transmission phase φ_{SP} of the metamaterial spaceplate (indicated by a line made of circles) and a fitted vacuum transfer phase φ_{BG} (indicated by the curved line). A global phase of an angle φ_{G}=−0.05 rad has been subtracted in the plotting, and the fitted compression factor R=4.9 (the inset graphic shows the transmission amplitude /H/).

On the right of FIG. 4B, the results of full-wave simulations of the square of the magnitude of the electric field, /E/², of a focusing Gaussian beam (waist of 3λ, divergence of 6°) are shown. More specifically on the top right of FIG. 4B, v indicates the beam propagating in a vacuum; pₛ indicates an s-polarized beam propagating through the metamaterial; pₚ indicates an p-polarized beam propagating through the metamaterial; and sp indicates the physical structure of the spaceplate to scale, which may include layers of Si and SiO₂. On the bottom right of FIG. 4B, e is a graphic of a cross-section of /E/² along the beam axis. Transmission through the spaceplate advances the focus position along the z-axis by Δ=−43.2 μm for both the p-polarized and the s-polarized light, as indicated by txₚ₊ₛ. For more details, see, e.g., Reshef 2021, p. 3 (FIG. 2).

FIG. 4C shows, on the left, a perspective view of a block diagram of a properly designed photonic crystal slab, and, on the right, four (4) different graphs q, r, s, and p of transfer functions of the photonic crystal slab on the left. Specifically on the left of FIG. 4C, a photonic crystal slab may include a square lattice of air holes, where the geometric parameters are r=0.111a, d=0.55a, dₛ=0.07a, d_{g}=0.94a, and a is the periodicity along the x and y directions. The yellow regions correspond to a material with permittivity ε=12. On the right of FIG. 4C, graphic q illustrates /tₛₛ/ as a function of in-plane wavevectors (kₓ, k_{y}); graphic r illustrates arg /tₛₛ/ as a function of in-plane wavevectors (kₓ, k_{y}); graphic s illustrates /tₛₛ/ as a function of in-plane wavevector magnitude |k|; and graphic p illustrates arg/tₛₛ/ as a function of in-plane wavevector magnitude |k| (along with a fit to a quadratic equation), where k₀=ωₒₚ/c is the wavenumber at the operating frequency ωₒₚ. For more details, see also, e.g., Guo et al., Squeeze free space with nonlocal flat optics, Optica, vol. 7, issue 9, pp. 1133-1138 (September 2020) (see esp., FIGS. 1(c) and 3), which is hereby incorporated by reference in its entirety.

FIG. 4D illustrates different normalized distributions (in red) of an electric field amplitude for the focusing of a transverse-electric (TE) polarized plane wave. More specifically, (a) illustrates the normalized distribution of an electric field amplitude for the focusing of a TE polarized plane wave by a local idealized metalens; (b) illustrates the normalized electric field amplitude distribution for the focusing of a TE polarized plane wave by the same local idealized metalens and a 5 layer nonlocal metasurface; and (c) illustrates the normalized electric field amplitude distribution for the focusing of a TE polarized plane wave by the same local idealized metalens and a 10 layer nonlocal metasurface. The dielectric nonlocal structure moves the focal plane closer and closer to the metalens, with minimal distortions and without changing the focal length of the metalens (which is a property of the local metalens itself). In (c), all space between the lens and the focal plane has been replaced and compressed by a nonlocal structure, thereby realizing a compact, planar, solid state focusing system. Indeed, the focal length F has shrunk from 44.9λ₀ to 8.7λ₀, which is the depth of the nonlocal metamaterial multi-layer stack. For more details, see also, e.g., Chen, A. & Monticone, F., Dielectric Nonlocal Metasurfaces for Fully Solid-State Ultrathin Optical Systems, ACS Photonics, vol. 8, issue 5, pp. 1439-1447 (2021) (see esp., FIGS. 5 and 4(e), and 4(f)), which is hereby incorporated by reference in its entirety.

Accordingly, a nonlocal metasurface space compressor, such as a spaceplate of multi-layer metasurfaces, according to examples of the present disclosure may substantially decrease the size of the illumination components required to establish the required distance for the focal plane to illuminate a user's eye for the eye/face tracking system of a near-eye device.

For additional details concerning the architecture and constructions of nonlocal metasurface space compressors such as multi-layer metasurface spaceplates, see, e.g., Zheng et al., Compound Meta-Optics for Complete and Loss-Less Field Control, ACS Nano 2022, 16, 15100-15107; https://doi.org/10.1021/acsnano.2c06248; (hereinafter, “Zheng 2022”), which is hereby incorporated by reference in its entirety, which discusses multilayer optical metasurfaces in the design space of flat optics which offer compact platforms for the manipulation of the amplitude, phase, and/or polarization state of light.

As used herein, the terms “nonlocal metasurface space compressor,” “nonlocal flat optics,” “spaceplate,” “flat optics,” “nonlocal spaceplate/metasurface,” “polarization-sensitive spaceplate,” “photonic crystal slab spaceplate,” “nonlocal multilayer polymer spaceplate,” and/or “multilayer thin film spaceplate” may be used interchangeably, depending upon the context, and are intended to be given the broadest interpretation, which should be understood by one of ordinary skill in the art as covering any one or more optical elements which use, inter alia, the principle of “compressing space” as discussed and described above in reference to Equation (1), using the materials and constructions as described and identified in the present disclosure.

Below, generally speaking, examples of different eye/face tracking light projection systems using one or more nonlocal metasurface space compressors in accordance with the present disclosure are described with reference to FIGS. 5A-5B, 6, 7, and 8; an example of eye/face tracking using one or more nonlocal metasurface space compressors in accordance with the present disclosure is described with reference to FIG. 9; and an example of manufacturing an eye/face tracking light projector integrated circuit including one or more nonlocal metasurface space compressors in accordance with the present disclosure is described with reference to FIG. 10.

### Non-Limiting Examples of Compact Light Projectors for Eye/Face Tracking Employing Nonlocal Flat Optics

FIG. 5A illustrates a light projection system 500A of an eye/face tracking system (such as, e.g., any of the eye/face tracking systems described in reference to FIGS. 1, 2A-2B, and 3A-3B above), which includes a nonlocal spaceplate/metasurface, according to an example of the present disclosure. FIG. 5A is provided to illustrate a general explanation herein of examples of an eye/face tracking light projection system using at least one nonlocal spaceplate/metasurface, and omits aspects, features, and/or components not germane to a general explanation of examples of an eye/face tracking light projection system using at least one nonlocal spaceplate/metasurface according to the present disclosure, as would be understood by one of ordinary skill in the art. Accordingly, the components shown in FIG. 5A may not be shown in accurate aspect and/or ratio of relative sizes (e.g., the relative sizes, shapes, and/or locations of the light source, the spaceplate, the beam-shaping element, the camera, the controller and its constituent components, etc., in FIG. 5A may in no way approximate the sizes, relative locations, and/or relative dimensions of those components in specific implementations and/or examples). In other words, FIG. 5A is intended to illustrate general concepts related to examples of the present disclosure, and is not intended to illustrate the sizes, proportions, relative aspects, etc., of the specific components shown in FIG. 5A, as would be understood by one of ordinary skill in the art.

As shown in FIG. 5A, the light projection system 500A may include a light source 505A, a spaceplate 510A, a beam shaping element 515A, a camera 520A, and a controller 530A (which may, in turn, include a processor 533A and a memory 535A). The light source 505A projects light through the spaceplate 510A and beam-shaping element 515A to create structured light 540A which is projected onto the user's eye. Reflections from the structured light 540A on the user's eye may be imaged by a camera 520A, which may provide the captured images to a controller 530A, which may perform eye/face tracking using the captured images. In some examples, the light source 505A, spaceplate 510A, and beam shaping element 515A may be included, in whole or part, in the inward projector(s) 173 of FIG. 1, the eye/face tracking projector(s) 315 of FIGS. 3A-3B, and/or any other eye/face tracking light projection system of any other near-eye device. In some examples, the camera 520A may be included, in whole or part, in the eye/face tracking unit 130 in FIG. 1, the eye/face tracking camera(s) 325 in FIGS. 3A and 3B, and/or any other eye/face tracking sensor system of any other near-eye device.

In FIG. 5A, the spaceplate 510A is polarization insensitive and may be used to minimize the distance between the light source 505A and the beam-shaping element 515A, thereby providing a reduction in size over a typical light projection system for eye/face tracking in a near-eye device.

In some examples, the spaceplate 510A may include multi-layer metasurfaces acting as nonlocal flat optics, as discussed and described herein and in Zheng 2022, cited above. In some examples, the spaceplate 510A may be a “sandwich” of a waveguide between two different metasurface layers, or the spaceplate 510A may include multiple layers of alternating waveguides and metasurfaces.

FIG. 5B illustrates a light projection system 500B of an eye/face tracking system (such as, e.g., any of the eye/face tracking systems described in reference to FIGS. 1, 2A-2B, and 3A-3B above), which includes a nonlocal spaceplate/metasurface, according to an example of the present disclosure. FIG. 5B is provided to illustrate a general explanation herein of examples of an eye/face tracking light projection system using at least one nonlocal spaceplate/metasurface, and omits aspects, features, and/or components not germane to a general explanation of examples of an eye/face tracking light projection system using at least one nonlocal spaceplate/metasurface according to the present disclosure, as would be understood by one of ordinary skill in the art. Accordingly, the components shown in FIG. 5B may not be shown in accurate aspect and/or ratio of relative sizes (e.g., the relative sizes, shapes, and/or locations of the light source, the spaceplate, the beam-shaping element, the camera, the controller and its constituent components, etc., in FIG. 5B may in no way approximate the sizes, relative locations, and/or relative dimensions of those components in specific implementations and/or examples). In other words, FIG. 5B is intended to illustrate general concepts related to examples of the present disclosure, and is not intended to illustrate the sizes, proportions, relative aspects, etc., of the specific components shown in FIG. 5B, as would be understood by one of ordinary skill in the art.

As shown in FIG. 5B, the light projection system 500B may include a light source 505B, a spaceplate 510B, and a beam shaping element 515B, a camera 520B, and a controller 530B (which may, in turn, include a processor 533B and a memory 535B). However, unlike the light projection system 500A in FIG. 5A, the light source 505B, spaceplate 510B, and beam shaping element 515B in FIG. 5B are combined into a monolithic compact light projector, thereby reducing the overall size of the light projection system 500B in comparison to the light projection system 500A.

Otherwise, similarly to FIG. 5A, in FIG. 5B, the light source 505B projects light through the spaceplate 510B and beam-shaping element 515B to create structured light 540B which is projected onto the user's eye. Reflections from the structured light 540B on the user's eye may be imaged by a camera 520B, which may provide the captured images to a controller 530B, which may perform eye/face tracking using the captured images. In some examples, the monolithic combination of the light source 505B, spaceplate 510B, and beam shaping element 515B may be included, in whole or part, in the inward projector(s) 173 of FIG. 1, the eye/face tracking projector(s) 315 of FIGS. 3A-3B, and/or any other eye/face tracking light projection system of any other near-eye device. In some examples, the camera 520B may be included, in whole or part, in the eye/face tracking unit 130 in FIG. 1, the eye/face tracking camera(s) 325 in FIGS. 3A and 3B, and/or any other eye/face tracking sensor system of any other near-eye device.

In FIG. 5B, as stated above, the monolithic combination of the light source 505B, spaceplate 510B, and beam shaping element 515B may reduce the overall size of the light projection system 500B, thereby providing a reduction in size over a typical light projection system for eye/face tracking in a near-eye device.

In FIGS. 5A and 5B, the light source 505A/B may be controllable by controller 530A/B and may include a laser, such as a Vertical Cavity Surface Emitting Lasers (VCSELs). In some examples, the light source may include one or more of a liquid crystal display (LCD), a light emitting diode (LED) or micro-light emitting diode (mLED), an organic light emitting diode (OLED), an inorganic light emitting diode (ILED), an active-matrix organic light emitting diode (AMOLED), a transparent organic light emitting diode (TLED), any other suitable light source, and/or any combination thereof. In any examples employing one or more VCSEL examples, the VCSEL may have one or more of a wide variety of possible VCSEL architectures, and/or fabrications, as would be understood by one of ordinary skill in the art. In such examples, the VCSEL may include a VCSEL with multiple active regions (e.g., a bipolar cascade VCSEL); a tunnel junction VCSEL; a tunable VCSEL which may employ, e.g., a micro-electromechanical system (MEMS); a wafer-bonded and/or wafer-fused VCSEL; a Vertical External Cavity Surface Emitting Laser (VECSEL); a Vertical Cavity Semiconductor Optical Amplifier (VCSOA) which may be optimized as amplifiers as opposed to oscillators; two or more Vertical Cavity Surface Emitting Lasers (VCSELs) disposed on top of one another (i.e., vertically) such that each one pumps the one on top of it (e.g., monolithically optically pumped VCSELs); any other suitable VCSEL construction, architecture, and/or fabrication, as would be understood by one of ordinary skill in the art in light of the examples of the present disclosure; and/or other constructions, architectures, and/or fabrications suitable for the present disclosure may be employed besides a VCSEL, such as—with appropriate architectural modifications, for example, an Edge-Emitting Laser (EEL), a Horizontal Cavity Surface Emitting Laser (HC-SEL), a Quantum Dot Laser (QDL), a Quantum Cascade Laser (QCL), a micro-Light Emitting Diode (mLED), any other form of solid state laser, and/or any light source suitable for examples according to the present disclosure, as would also be understood by one of ordinary skill in the art.

In FIGS. 5A and 5B, the spaceplate 510A/B may be any form or type of nonlocal metasurface space compressor, as discussed above in reference to FIGS. 4A-4D. In some examples, the spaceplate 510A/B may be a multi-layer metasurface with a metalens substrate, such as shown in FIG. 4D (c). In other examples, the spaceplate 510A/B may include multiple layers of metasurfaces and/or nanostructures which collectively act as nonlocal flat optics, as described herein and in Zheng 2022, cited above. In some examples, the spaceplate 510A/B may be a “sandwich” of a waveguide between two different metasurface layers, or the spaceplate 510A/B may include multiple layers of alternating waveguides and metasurfaces.

In FIGS. 5A and 5B, the beam-shaping element 515A/B may include any suitable components for light modification, such as, for example, refractive elements, reflective elements, polarization elements, a Pancharatnam-Berry phase (PBP) or other phase-modification elements, diffractive gratings (such as, e.g. Polarization Volumetric Hologram-based (PVH) gratings, Surface Relief Gratings (SRGs), Volume Bragg Gratings (VBGs), a diffractive optical element (DOE), etc.), nano-optics (including, e.g., metalenses and metasurfaces), micro-structures (including those fabricated using 3D printing), surface coatings, lithographically-created layered waveguides, and/or any other suitable technique, technology, layer, coating, and/or material feasible and/or possible either presently or in the future, as would be understood by one of ordinary skill in the art.

As shown in FIGS. 5A and 5B, the light source 505A/B, spaceplate 510A/B, and beam shaping element 515A/B of the eye/face tracking light projection system 500A/B may be operably and communicatively connected to, and/or controlled by, the controller 530A/B which may include, and/or may be communicatively connected to, the processor 533A/B and/or the memory 535A/B, which may be a non-transitory computer-readable storage medium (and may store instructions executable by the processor 533A/B and/or the controller 530A/B). In some examples, the controller 530A/B may control and/or send/receive data and other signals from the light source 505A/B, spaceplate 510A/B, and beam shaping element 515A/B, and may further process and/or perform functions upon any such received signals. In some examples, the processor 533A/B in the controller 530A/B may perform any of the methods, functions, and/or processes described in any portion of the present disclosure by executing instructions contained on the memory 535A/B and/or another suitable non-transitory computer-readable storage medium. In some examples, the controller 530A/B may be included, in whole or part, in the processor(s) 121, the eye/face tracking unit 118, and/or the eye/face tracking unit 130 in FIG. 1, the controller(s) 317 in FIG. 3B, any other eye/face tracking processing system, and/or any other processing or controlling module which may be used in a near-eye device, as would be understood by one of ordinary skill in the art.

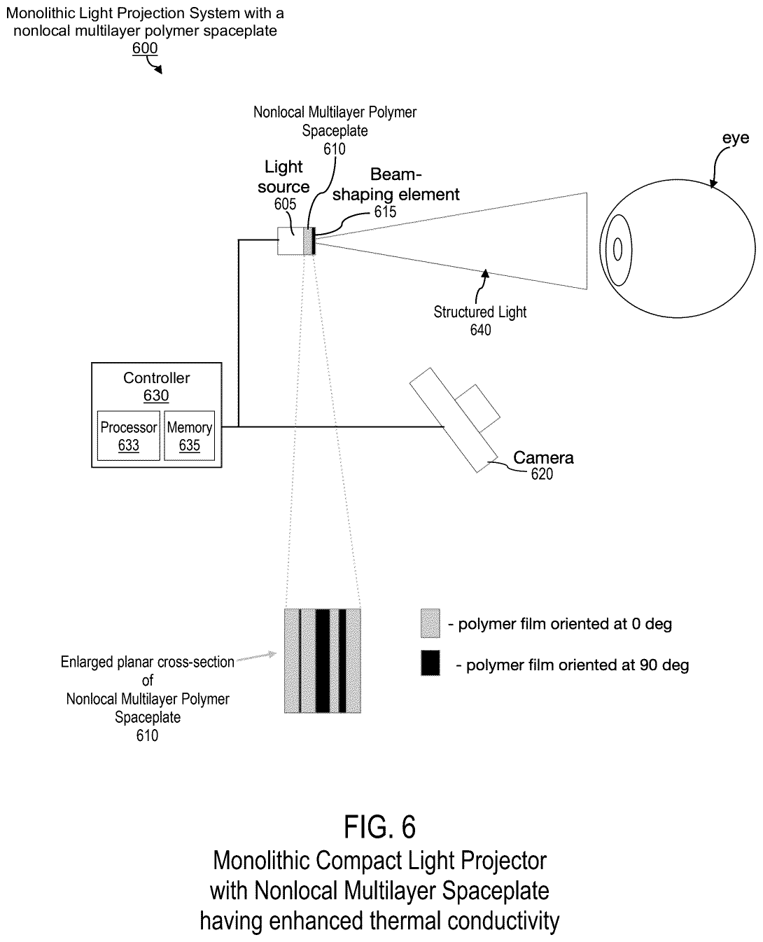

FIG. 6 illustrates a monolithic light projection system 600 of an eye/face tracking system (such as, e.g., any of the eye/face tracking systems described in reference to FIGS. 1, 2A-2B, and 3A-3B above), which includes a nonlocal multilayer polymer spaceplate, according to an example of the present disclosure. FIG. 6 is provided to illustrate a general explanation herein of examples of an eye/face tracking light projection system using at least one nonlocal multilayer polymer spaceplate, and omits aspects, features, and/or components not germane to a general explanation of examples of an eye/face tracking light projection system using at least one nonlocal multilayer polymer spaceplate according to the present disclosure, as would be understood by one of ordinary skill in the art. Accordingly, the components shown in FIG. 6 may not be shown in accurate aspect and/or ratio of relative sizes (e.g., the relative sizes, shapes, and/or locations of the light source, the multilayer polymer spaceplate and its constituent components, the beam-shaping element, the camera, the controller and its constituent components, etc., in FIG. 6 may in no way approximate the sizes, relative locations, and/or relative dimensions of those components in specific implementations and/or examples). In other words, FIG. 6 is intended to illustrate general concepts related to examples of the present disclosure, and is not intended to illustrate the sizes, proportions, relative aspects, etc., of the specific components shown in FIG. 6, as would be understood by one of ordinary skill in the art.

In FIG. 6, the monolithic light projection system 600 may include a light source 605, a nonlocal multilayer polymer spaceplate 610, and a beam shaping element 615 combined together as a monolithic compact light projector like in FIG. 5B; a camera 620; and a controller 630 (which may, in turn, include a processor 633 and a memory 635).

However, as shown in FIG. 6, the spaceplate 610 is a nonlocal multilayer polymer spaceplate which may be manufactured from multiple layers of orthogonally aligned polymer film layers. As shown in the enlarged planar cross-sectional view at the bottom of FIG. 6, the nonlocal multilayer polymer spaceplate 610 may include various layers of polymer, of varying thicknesses, where some layers are oriented at 0° (in light gray) and other layers are aligned at 90° (in black)—i.e., the layers are orthogonally oriented to each other. When constructed using suitable polymers via a stretching process, such a nonlocal multilayer polymer spaceplate 610 may also have beneficial thermal conductive benefits and may thus be employed to dissipate heat. For specific non-limiting examples, see, e.g., Zhang et al., Constructing highly oriented and condensed shish-kebab crystalline structure of HDPE/UHMWPE blends via intense stretching process: Achieving high mechanical properties and in-plane thermal conductivity, Polymer 241 (2022) 124532; https://doi.org/10.1016/j.polymer.2022. 124532; (2022) (hereinafter, “Zhang 2022”), which discusses using an highly intense stretching process to construct a highly oriented and condensed shish-kebab crystalline structure that has both enhanced mechanical properties and in-plane thermal conductivity, from blends of high density polyethylene (HDPE) and ultra-high molecular weight polyethylene (UHMWPE), and which is incorporated by reference in its entirety.

Otherwise in FIG. 6, similarly to FIGS. 5A-5B, the light source 605 projects light through the nonlocal multilayer polymer spaceplate 610 and beam-shaping element 615 to create structured light 640 which is projected onto the user's eye. Reflections from the structured light 640 on the user's eye may be imaged by the camera 620, which may provide the captured images to the controller 630, which may perform eye/face tracking using the captured images. In some examples, the monolithic combination of the light source 605, the nonlocal multilayer polymer spaceplate 610, and beam shaping element 615 may be included, in whole or part, in the inward projector(s) 173 of FIG. 1, the eye/face tracking projector(s) 315 of FIGS. 3A-3B, and/or any other eye/face tracking light projection system of any other near-eye device. In some examples, the camera 620 may be included, in whole or part, in the eye/face tracking unit 130 in FIG. 1, the eye/face tracking camera(s) 325 in FIGS. 3A and 3B, and/or any other eye/face tracking sensor system of any other near-eye device. In FIG. 6, the light source 605 and beam-forming element 615 may include a similar construction, implementation, and/or architecture as that discussed in reference to light source 505A/B and beam-forming element 515A/B, respectively, in FIGS. 5A-5B.

In FIG. 6, similarly to the examples above, the monolithic compact light projector of the light source 605, spaceplate 610, and beam shaping element 615 may reduce the overall size of the light projection system 600, thereby providing a reduction in size over a typical light projection system for eye/face tracking in a near-eye device.

Moreover, in FIG. 6, the nonlocal multilayer polymer spaceplate 610 may be manufactured from multiple layers of alternating orthogonally oriented polymers and provide a secondary benefit of acting as a heat conductor to dissipate the heat generated by the light source 605.

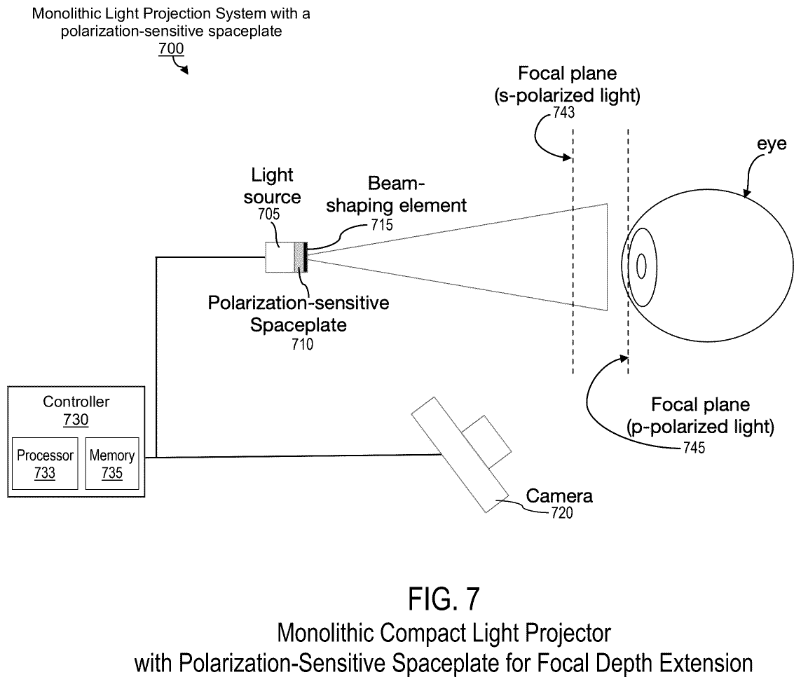

FIG. 7 illustrates a monolithic light projection system 700 of an eye/face tracking system (such as, e.g., any of the eye/face tracking systems described in reference to FIGS. 1, 2A-2B, and 3A-3B above), which includes a polarization-sensitive spaceplate for focal depth extension, according to an example of the present disclosure. FIG. 7 is provided to illustrate a general explanation herein of examples of an eye/face tracking light projection system using a polarization-sensitive spaceplate for focal depth extension, and omits aspects, features, and/or components not germane to a general explanation of examples of an eye/face tracking light projection system using a polarization-sensitive spaceplate for focal depth extension according to the present disclosure, as would be understood by one of ordinary skill in the art. Accordingly, the components shown in FIG. 7 may not be shown in accurate aspect and/or ratio of relative sizes (e.g., the relative sizes, shapes, and/or locations of the light source, the polarization-sensitive spaceplate, the beam-shaping element, the camera, the controller and its constituent components, etc., in FIG. 7 may in no way approximate the sizes, relative locations, and/or relative dimensions of those components in specific implementations and/or examples). In other words, FIG. 7 is intended to illustrate general concepts related to examples of the present disclosure, and is not intended to illustrate the sizes, proportions, relative aspects, etc., of the specific components shown in FIG. 7, as would be understood by one of ordinary skill in the art.

In FIG. 7, the monolithic light projection system 700 may include a light source 705, a polarization-sensitive spaceplate 710, and a beam shaping element 715 combined together as a monolithic compact light projector like in FIGS. 5B and 6; a camera 720; and a controller 730 (which may, in turn, include a processor 733 and a memory 735).

However, as shown in FIG. 7, the spaceplate 710 is a polarization-sensitive spaceplate which may provide different delays for s-polarized and p-polarized light, resulting in two different focal planes: an s-polarized focal plane 743 and a p-polarized focal plane 745. If the pattern projected at the s-polarized focal plane 743 and the p-polarized focal plane 745 is orthogonally aligned and has the same spatial frequency, the pattern may be in-focus at either of the s-polarized focal plane 743 or the p-polarized focal plane 745, thereby providing extended depth information regarding the user's eye.

Accordingly, in some examples, the light source 705 in FIG. 7 projects light through the polarization-sensitive spaceplate 710 to create structured light having an orthogonally-aligned pattern with the same spatial frequency projected at the s-polarized focal plane 743 and the p-polarized focal plane 745. Reflections from the structured light at the s-polarized focal plane 743 and the p-polarized focal plane 745 on and/or near the user's eye may be imaged by the camera 720, which may provide the captured images to the controller 730, which may perform eye/face tracking using the captured images. More specifically, the controller 730 may perform eye/face tracking by determining location, orientation, etc., of the user's eye using extended depth information provided by the reflections from the structured light at the s-polarized focal plane 743 and the p-polarized focal plane 745 on and/or near the user's eye.

In other examples, the light source 705 in FIG. 7 projects light through the polarization-sensitive spaceplate 710 to create structured light having a pattern projected at the s-polarized focal plane 743 which is not orthogonally aligned with the pattern projected at the p-polarized focal plane 745. In yet other examples, the light source 705 in FIG. 7 projects light through the polarization-sensitive spaceplate 710 to create structured light having a pattern projected at the s-polarized focal plane 743 with a different spatial frequency than the pattern projected at the p-polarized focal plane 745. In some other examples, the patterns may be neither orthogonally aligned nor have the same spatial frequency—in any of these instances, additional depth information may be provided by these pattern differences at the different focal planes. Accordingly, when reflections from the s-polarized focal plane 743 and the p-polarized focal plane 745 are imaged by the camera 720 and provided to the controller 730, the captured images may be utilized to perform eye/face tracking with even great depth detail.

In some examples, the monolithic combination of the light source 705, polarization-sensitive spaceplate 710, and beam shaping element 715 may be included, in whole or part, in the inward projector(s) 173 of FIG. 1, the eye/face tracking projector(s) 315 of FIGS. 3A-3B, and/or any other eye/face tracking light projection system of any other near-eye device. In some examples, the camera 720 may be included, in whole or part, in the eye/face tracking unit 130 in FIG. 1, the eye/face tracking camera(s) 325 in FIGS. 3A and 3B, and/or any other eye/face tracking sensor system of any other near-eye device. In FIG. 7, the light source 705 and the beam-forming element 715 may include a similar construction, implementation, and/or architecture as that discussed in reference to light source 505A/B and beam-forming element 515A/B, respectively, in FIGS. 5A-5B.

In FIG. 7, the polarization-sensitive spaceplate 710 may be any form or type of nonlocal metasurface space compressor, as discussed above in reference to FIGS. 4A-4D and 5A-5B, including a construction of multi-layer metasurfaces/metalenses. In some examples, the polarization-sensitive spaceplate 710 may be a “sandwich” of a waveguide between two different metasurface layers, or the polarization-sensitive spaceplate 710 may include multiple layers of alternating waveguides and metasurfaces. How to make the spaceplate 710 polarization-sensitive as described herein may be implemented in a number of ways, as would be understood by one of ordinary skill in the art, and may vary depending on the construction type, materials used, etc. For some examples, see Zheng 2022, cited above.

In FIG. 7, similarly to the examples above, the monolithic compact light projector of the light source 705, polarization-sensitive spaceplate 710, and beam shaping element 715 may reduce the overall size of the light projection system 700, thereby providing a reduction in size over a typical light projection system for eye/face tracking in a near-eye device.

Moreover, in FIG. 7, the polarization-sensitive spaceplate 710 may provide different focal planes for light having different polarizations, thereby providing additional depth information for the eye/face tracking system of the near-eye device.

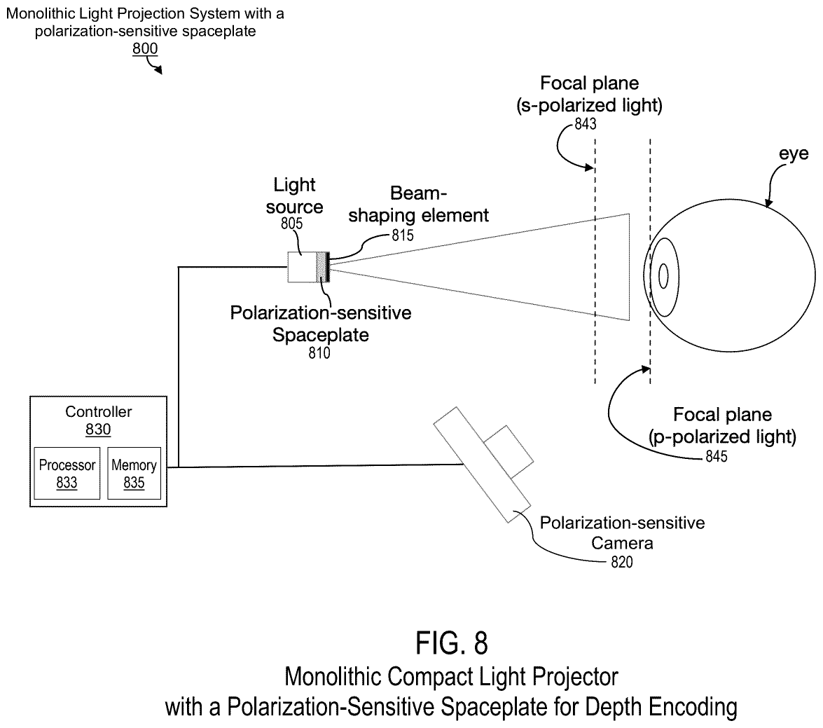

FIG. 8 illustrates a monolithic light projection system 800 of an eye/face tracking system (such as, e.g., any of the eye/face tracking systems described in reference to FIGS. 1, 2A-2B, and 3A-3B above), which includes a polarization-sensitive spaceplate for depth encoding, according to an example of the present disclosure. FIG. 8 is provided to illustrate a general explanation herein of examples of an eye/face tracking light projection system using a polarization-sensitive spaceplate for depth encoding, and omits aspects, features, and/or components not germane to a general explanation of examples of an eye/face tracking light projection system using a polarization-sensitive spaceplate for depth encoding according to the present disclosure, as would be understood by one of ordinary skill in the art. Accordingly, the components shown in FIG. 8 may not be shown in accurate aspect and/or ratio of relative sizes (e.g., the relative sizes, shapes, and/or locations of the light source, the polarization-sensitive spaceplate, the beam-shaping element, the camera, the controller and its constituent components, etc., in FIG. 8 may in no way approximate the sizes, relative locations, and/or relative dimensions of those components in specific implementations and/or examples). In other words, FIG. 8 is intended to illustrate general concepts related to examples of the present disclosure, and is not intended to illustrate the sizes, proportions, relative aspects, etc., of the specific components shown in FIG. 8, as would be understood by one of ordinary skill in the art.

In FIG. 8, the monolithic light projection system 700 may include a light source 805, a polarization-sensitive spaceplate 810, and a beam shaping element 815 combined together as a monolithic compact light projector like in FIGS. 5B, 6, and 7; a polarization-sensitive camera 820; and a controller 830 (which may, in turn, include a processor 833 and a memory 835).

Like FIG. 7, the spaceplate 810 in FIG. 8 is a polarization-sensitive spaceplate which may provide different delays for s-polarized and p-polarized light, resulting in two different focal planes: an s-polarized focal plane 843 and a p-polarized focal plane 845. Also similarly to FIG. 7, the polarization-sensitive spaceplate 810 may be a construction of multi-layer metasurfaces/metalenses, or any other form or type of nonlocal metasurface space compressor, as discussed above in reference to FIGS. 4A-4D and 5A-5B. In some examples, the polarization-sensitive spaceplate 810 may be a “sandwich” of a waveguide between two different metasurface layers, or the polarization-sensitive spaceplate 810 may include multiple layers of alternating waveguides and metasurfaces. The spaceplate 810 may be constructed to be polarization-sensitive in a number of ways, as would be understood by one of ordinary skill in the art, and such constructions/architecture may vary depending on the type of spaceplate (or other nonlocal metasurface space compressor), the materials used, the fabrication method, etc. For some examples, see Zheng 2022, cited above.

However, unlike FIG. 7, the camera 820 in FIG. 8 is a polarization-sensitive camera and therefore may detect different polarizations within the reflections received back from the structured light at the s-polarized focal plane 843 and the p-polarized focal plane 845 on and/or near the user's eye.

Accordingly, in some examples, the light source 805 in FIG. 8 may project light through the polarization-sensitive spaceplate 810 to create structured light having (i) orthogonally-aligned or orthogonally unaligned patterns, with (ii) the same or different spatial frequencies, projected at the s-polarized focal plane 843 and the p-polarized focal plane 845. Reflections from the structured light at the s-polarized focal plane 843 and the p-polarized focal plane 845 on and/or near the user's eye may be imaged by the polarization-sensitive camera 820, which may provide the captured images to the controller 830, which may perform eye/face tracking using the captured images which will have polarization information as well as the pattern sharpness information provided by the polarization-insensitive camera 720 in FIG. 7. More specifically, the controller 830 may perform eye/face tracking by determining location, orientation, etc., of the user's eye using the additional polarization information as well as the extended depth information provided by the reflections from the structured light at the s-polarized focal plane 843 and the p-polarized focal plane 845 on and/or near the user's eye.

In some examples, the monolithic combination of the light source 805, polarization-sensitive spaceplate 810, and beam shaping element 815 may be included, in whole or part, in the inward projector(s) 173 of FIG. 1, the eye/face tracking projector(s) 315 of FIGS. 3A-3B, and/or any other eye/face tracking light projection system of any other near-eye device. In some examples, the polarization-sensitive camera 820 may be included, in whole or part, in the eye/face tracking unit 130 in FIG. 1, the eye/face tracking camera(s) 325 in FIGS. 3A and 3B, and/or any other eye/face tracking sensor system of any other near-eye device. In FIG. 8, the light source 785 and beam-forming element 815 may include a similar construction, implementation, and/or architecture as that discussed in reference to light source 505A/B and beam-forming element 515A/B, respectively, in FIGS. 5A-5B.

In FIG. 8, similarly to the examples above, the monolithic compact light projector of the light source 805, polarization-sensitive spaceplate 810, and beam shaping element 815 may reduce the overall size of the light projection system 800, thereby providing a reduction in size over a typical light projection system for eye/face tracking in a near-eye device.

Moreover, in FIG. 8, the polarization-sensitive spaceplate 810 may provide different focal planes for light having different polarizations, thereby providing additional depth information for the eye/face tracking system of the near-eye device.

Furthermore, the polarization-sensitive camera 820 in FIG. 8 may provide additional polarization data when it captures images of the reflections from the different focal planes, thereby providing yet a further level of depth information for the eye/face tracking system of the near-eye device.

As shown in FIGS. 6, 7, and 8, similarly to FIGS. 5A-5B, the light source(s) 605, 705, and/or 805, respectively, the spaceplate(s) 610, 710, and/or 810, respectively, and the beam shaping element(s) 615, 715, and/or 815, respectively, of the eye/face tracking light projection system(s) 600, 700, and/or 800, respectively, may be operably and communicatively connected to, and/or controlled by, a controller 630, 730, and/or 830, respectively, which may include, and/or may be communicatively connected to, a processor 633, 733, and/or 833, respectively, and/or a memory 635, 735, and/or 835, respectively, which may be a non-transitory computer-readable storage medium. In some examples, the controller 630, 730, and/or 830 may control and/or send/receive data and other signals from the light source 605, 705, and/or 805, spaceplate 610, 710, and/or 810, and beam shaping element 615, 715, and/or 815, and may further process and/or perform functions upon any such received signals. In some examples, the processor 633, 733, and/or 833 in the controller 630, 730, and/or 830 may perform any of the methods, functions, and/or processes described in any portion of the present disclosure by executing instructions contained on the memory 635, 735, and/or 835, and/or another suitable non-transitory computer-readable storage medium. In some examples, the controller 630, 730, and/or 830 may be included, in whole or part, in the processor(s) 121, the eye/face tracking unit 118, and/or the eye/face tracking unit 130 in FIG. 1, the controller(s) 317 in FIG. 3B, any other eye/face tracking processing system, and/or any other processing or controlling module which may be used in a near-eye device, as would be understood by one of ordinary skill in the art.

### Non-Limiting Example of Eye/Face Tracking Method

FIG. 9 is a flowchart illustrating a method for eye/face tracking using a light projection system including one or more nonlocal metasurface space compressors, according to an example of the present disclosure. The method 900 shown in FIG. 9 is provided by way of example and may only be one part of an entire process, procedure, ongoing operation, method, etc., as would be understood by one of ordinary skill in the art. The method 900 may further omit parts of any process, procedure, ongoing operation, method, etc., involved in eye/face tracking not germane to examples of the present disclosure, as would be understood by one of ordinary skill in the art. Each block shown in FIG. 9 may further represent one or more steps, processes, methods, or subroutines, as would be understood by one of ordinary skill in the art. For the sake of convenience and ease of explanation, the blocks in FIG. 9 may refer to the components shown in the FIGS. described herein; however, the method 900 is not limited in any way to the components, apparatuses, and/or constructions described and/or shown in any of the FIGS. herein.

Some of the processes indicated by the blocks in FIG. 9 may overlap, occur substantially simultaneously, and/or be continually repeated, and, moreover, the blocks may be performed by different processing components. In some examples, the components performing any of blocks in FIG. 9 may be controlled/directed to do so by one or more controllers/processors (such as, for example, the controllers 530A/B in FIGS. 5A-5B, the controller 630 in FIG. 6, the controller 730 in FIG. 7, the controller 830 in FIG. 8, the controller(s) 317 in FIG. 3B, the eye/face tracking unit 130, the eye/face tracking module 118, and/or the processor(s) 121 of FIG. 1, and/or any other suitable processor/controller, as would be understood by one of ordinary skill in the art).

At block 910, an eye/face tracking light projection system utilizing one or more nonlocal metasurface space compressors may project/emit structured light towards the user's eye and/or surrounding facial tissue. In some examples, the light projection system may be any of eye/face tracking light projection systems 500A, 500B, 600, 700, and/or 800 in FIGS. 5A, 5B, 6, 7, and/or 8, respectively. In some examples, the one or more nonlocal metasurface compressors may include, for example, the spaceplate 510A/B, the nonlocal multilayer polymer spaceplate 610, the polarization-sensitive spaceplate 710, and/or the polarization-sensitive spaceplate 810 of FIGS. 5A/B, 6, 7, and/or 8, respectively. In some examples having, e.g., a polarization-sensitive spaceplate, the structured light may project differentially-polarized light having different focal lengths, such as described in reference to FIGS. 7 and 8. In some examples having, e.g., a polarization-sensitive spaceplate, the structured light may project patterns with varying spatial frequency at the same or different focal lengths, such as described in reference to FIGS. 7 and 8.

In some examples, the structured light may include one or more patterns. In some examples, the projected structured light may include, for example, one or more of a statistically random pattern (such as, e.g., a pattern of dots or a pattern of speckles), an interference pattern (such as, e.g., a moire pattern or a fringe pattern), a sinusoidal pattern, a binary pattern, a multi-level pattern (such as, e.g., a multi-level grayscale pattern), a code-based pattern, a color-based pattern, and a geometrical pattern (such as, e.g., a triangular, pyramidal, or trapezoidal pattern), as would be understood by one of ordinary skill in the art. Moreoever, in various examples of the present disclosure, there may be only one projected pattern, or a multitude of patterns, or a series of related patterns, which may be projected either separately, in a time series, or simultaneously, as would be understood by one of ordinary skill in the art. In some examples, periodic patterns (such as, e.g., fringe patterns) and/or non-periodic patterns (such as, e.g., speckle patterns) may be employed.

At block 920, one or more eye/face tracking sensors capture images of reflections of the projected structured light from the user's eye and/or surrounding facial tissue. In some examples, the eye/face tracking sensors may be any of camera 520A/B, camera 620, camera 720, and/or polarization-sensitive camera 820 in FIGS. 5A/B, 6, 7, and/or 8, respectively. In some examples, the eye/face tracking sensors may capture image information concerning pattern focus/sharpness, focal depth extension, depth encoding, polarizations, and/or differential data created by the structured light projected through the one or more nonlocal metasurface space compressors.

At block 930, the captured images of the reflections of the structured light from the user's eye and/or surrounding facial tissue are processed. In some examples, any of controllers 530A, 530B, 630, 730, and/or 830 in FIGS. 5A, 5B, 6, 7, and/or 8, respectively, may perform this processing. In some examples, the processing of block 930 may create usable data from the captured image information concerning pattern focus/sharpness, focal depth extension, depth encoding, polarizations, and/or differential data created by the structured light projected through the one or more nonlocal metasurface space compressors.

At block 940, the eye/face tracking system performs eye/face tracking utilizing the processing from block 930. In some examples, the eye/face tracking system may include any of controllers 530A, 530B, 630, 730, and/or 830 in FIGS. 5A, 5B, 6, 7, and/or 8, respectively. In some examples, the eye/face tracking in block 940 may provide data concerning, for example, the shape of the user's eye (e.g., a depth map), the location of the pupil, the direction of the user's gaze, the line and/or angular velocity of the user's eye, the direction of movement of the user's eye, acceleration, etc., and/or details, characteristics, and/or parameters regarding the user's face, as would be understood by one of ordinary skill in the art.

### Non-Limiting Example of Manufacturing/Fabrication Method

FIG. 10 is a flowchart illustrating a method for manufacturing a monolithic compact light projector having a spaceplate, which may be employed for eye/face tracking in a near-eye device according to examples of the present disclosure. The method 1000 shown in FIG. 10 is provided by way of example and may only be one part of an entire manufacturing process, as would be understood by one of ordinary skill in the art. The method 1000 may further omit parts of any process, procedure, ongoing operation, method, etc., involved in manufacturing a monolithic compact light projector having a spaceplate not germane to examples of the present disclosure, as would be understood by one of ordinary skill in the art. Each block shown in FIG. 10 may further represent one or more steps, processes, methods, or subroutines, as would be understood by one of ordinary skill in the art. In some examples, the processes in the blocks of FIG. 10 may overlap and/or may occur substantially simultaneously. For the sake of convenience and ease of explanation, the blocks in FIG. 10 may refer to the components shown in the FIGS. described herein; however, the method 1000 is not limited in any way to the components, apparatuses, and/or constructions described and/or shown in any of the FIGS. herein.

In some examples, the monolithic compact light projector having a spaceplate which may be employed for eye/face tracking in a near-eye device, which may be manufactured according to the example method 1000 described in relation to FIG. 10, may be any of the monolithic compact light projectors in FIGS. 5B, 6, 7 and/or 8. In the method 1000 of FIG. 10, the monolithic compact light projector having a spaceplate may be fabricated as an integrated circuit (or “chip”) using a lithographic technique. Accordingly, for purposes of convenience, the monolithic compact light projector having a spaceplate which may be employed for eye/face tracking in a near-eye device may be referred to, in relation to FIG. 10, as an “eye/face tracking nonlocal space compressed light projector chip.”

As stated above, the method 1000 of manufacturing may employ lithography, including, for example, such techniques as photolithography (including, e.g., optical lithography and quantum optical lithography), scanning lithography (including, e.g., electron-beam lithography, scanning probe lithography, proton beam writing, charged particle lithography, etc.), soft lithography (including, e.g., polydimethylsiloxance (PDMS) lithography, microcontact printing, multilayer soft lithography, etc.), nanoimprint lithography, magnetolithography, nanofountain drawing, nanosphere lithography, neural particle lithography, plasmonic lithography, stencil lithography, and/or any other past, present, or future lithographic technique suitable for fabricating an integrated circuit, optical module, and/or chip in accordance with the present disclosure, as would be understood by one of ordinary skill in the art.

At block 1010, the method 1000 may start manufacturing an eye/face tracking nonlocal space compressed light projector chip by epitaxially depositing semiconductor and/or dielectric layers on a substrate. In some examples, the substrate may be Gallium Arsenide (GaAs), Aluminum Arsenide (AlAs), any of the various types of silicon (e.g., Silicon Dioxide (SiO₂), Silicon Nitride (SiN), etc.), etc., as would be understood by one of ordinary skill in the art.

At block 1020, the method 1000 may provide one or more layers constituting a Vertical Cavity Surface Emitting Laser (VCSEL) upon the substrate/dielectric layer(s) from block 1010. In some examples, another type of light source may be employed. In some examples, the VCSEL in block 1020 may be any of light source(s) 510A/B, 610, 710, and/or 810 in FIGS. 5A/B, 6, 7, and/or 8, respectively. In some examples, the VCSEL may include a bottom reflector layer, an active region/optical cavity layer, and a top reflector layer. In some examples, the top and bottom layers may be distributed Bragg reflector (DBR) layers; in other examples, there may also be a middle reflector layer (which may include, e.g., an n-doped distributed Bragg reflector (n-DBR) layer).

In some examples, the one or more layers constituting the active region/optical cavity may include a photon absorption layer, such as, e.g., an Indium Gallium Arsenide (InGaAs) layer, and/or a resonant optical cavity. In some examples, the one or more layers constituting the active region/optical cavity may include one or more quantum wells, in single quantum well or multiple quantum well (MQW) structures. In some examples, the one or more layers constituting the active region/optical cavity may include an aperture through which laser light may be guided and through which a current applied to the eye/face tracking nonlocal space compressed light projector chip may be constricted.

At block 1030, the method 1000 may provide one or more layers constituting a spaceplate upon the VCSEL layer(s) from block 1020. In some examples, another type of nonlocal metasurface space compressor may be employed. In some examples, the spaceplate in block 1030 may be any of the spaceplate 510A/B, the nonlocal multilayer polymer spaceplate 610, the polarization-sensitive spaceplate 710, and/or the polarization-sensitive spaceplate 810 in FIGS. 5A/B, 6, 7, and/or 8, respectively. In some examples, a spaceplate such as shown in FIG. 4A may be provided in block 1030. In some examples, the multilayer physical structure indicated by reference sp in FIG. 4B may be provided as the spaceplate in block 1030. In some examples, the photonic crystal slab spaceplate physical structure shown on the left in FIG. 4C may be provided as the spaceplate in block 1030. In some examples, a combination of one or more metalenses and one or more nonlocal metasurface layers such as shown in FIG. 4D may be provided in block 1030.

In some examples, a multilayer spaceplate may be separately manufactured and then affixed, attached, and/or deposited in block 1030. For instance, an HDPE/UHMWPE blend crystalline structure such as described in Zhang 2022 and mentioned above in reference to FIG. 6 may be separately constructed and then suitably affixed in block 1030. As another instance, multilayer cascading metasurface constructions described in Zheng 2022, cited above, may be separately constructed and then suitably affixed in block 1030. In other instances, the fabrication techniques for constructions such as discussed in Zhang 2022 and/or Zheng 2022 may be integrated into an overall manufacturing method 1000.

At block 1040, the method 1000 may provide one or more layers constituting a beam-forming element upon the spaceplate layer(s) from block 1030. In some examples, the beam-forming element in block 1040 may be any of beam-forming element(s) 515A/B, 615, 715, and/or 815 in FIGS. 5A/B, 6, 7, and/or 8, respectively. In some examples, the beam-forming element in block 1040 may include any suitable components for light modification, such as, for example, refractive elements, reflective elements, polarization elements, a Pancharatnam-Berry phase (PBP) or other phase-modification elements, diffractive gratings (such as, e.g. Polarization Volumetric Hologram-based (PVH) gratings, Surface Relief Gratings (SRGs), Volume Bragg Gratings (VBGs), a diffractive optical element (DOE), etc.), nano-optics (including, e.g., metalenses and metasurfaces), micro-structures (including those fabricated using 3D printing), surface coatings, lithographically-created layered waveguides, and/or any other suitable technique, technology, layer, coating, and/or material feasible and/or possible either presently or in the future, as would be understood by one of ordinary skill in the art.

As would be understood by one of ordinary skill in the art, any of the layers named in the method 1000 of FIG. 10 may, in some examples, include many constituent layers and/or may be integrated together into larger layers. Conversely, there may be many more layers than just the layers named herein, as would be understood by one of ordinary skill in the art. In some examples, electrical contacts may be included in any of the layers named in the method 1000 of FIG. 10 for purposes of control, management, and power of components/layers of the eye/face tracking nonlocal space compressed light projector chip. For instance, the method 1000 may provide a top surface for the eye/face tracking nonlocal space compressed light projector chip, which may include, for example, an emitting surface layer, a passivation layer, a surface grating (such as, e.g., a diffractive grating, relief grating, high-contrast grating, etc.), a metasurface and/or metalens, a micromechanical system (MEMS), a liquid lens, a mask (such as, e.g., a phase mask), etc., as would be understood by one of ordinary skill in the art. In some examples, the top layer may be a mask suited for projecting light from a self-mixing interferometer (SMI) eye/face tracking sensor. For instance, constructions similar to those described in U.S. Pat. Pub. No. 2022/0317438, assigned to the same assignee as hereto, may be employed.

In some examples, regardless of whether mentioned specifically herein, the method 1000 of manufacturing may employ any of the various techniques of wafer processing, die preparation, packaging, and/or testing. In some examples, the method 1000 of manufacturing may employ wafer processing techniques including, but not limited to, wet cleans (including, e.g., wafer scrubbing and/or cleaning by solvents and/or solutions); surface passivation; ion implantation; molecular beam epitaxy (MBE); plasma ashing; thermal treatments (such as, e.g., rapid thermal anneal, furnace anneals, thermal oxidation, etc.); Electrochemical Deposition (ECD) and/or electroplating; Chemical Vapor Deposition (CVD); Atomic Layer Deposition (ALD); Physical Vapor Deposition (PVD) (including, e.g., sputtering, evaporation, etc.); Chemical Mechanical Polishing (CMP); photolithographic techniques (such as, e.g., photoresist coating, photoresist baking, edge bead removal, exposure, development, Post Exposure Baking (PEB), etc.); etching or microfabrication (such as, e.g., dry or plasma etching, including Reactive lon Etching (RIE) and Atomic Layer Etching (ALE), and/or wet etching, including, e.g., a buffered oxide etch); laser lift-off; wafer testing, etc., as would be understood by one of ordinary skill in the art.

In some examples, the method 1000 of manufacturing may employ die preparation techniques including, but not limited to, through-silicon via (TSV), wafer mounting with dicing tape, wafer backgrinding and polishing, wafer bonding and stacking, redistribution layer manufacture, wafer bumping, die cutting, wafer dicing, etc., as would be understood by one of ordinary skill in the art. In some examples, the method 1000 of manufacturing may employ integrated circuit packaging techniques including, but not limited to, die attachment, bonding (such as, e.g., wire bonding, thermosonic bonding, flip chip or Tape Automated Bonding (TAB)), encapsulation (such as, e.g., integrated heat spreader (HIS) installation, molding, baking, electroplating, laser marking, silkscreen printing, trimming and forming, and the like), etc., as would be understood by one of ordinary skill in the art.

According to examples, systems and apparatuses for eye/face tracking in a near-eye device using a compact light projector including a nonlocal metasurface space compressor are described herein. One or more methods for eye/face tracking in a near-eye device using a compact light projector including a nonlocal metasurface space compressor are also described herein. One or more methods and/or systems for manufacturing a compact light projector for eye/face tracking in a near-eye device which includes a nonlocal metasurface space compressor are also described herein. A non-transitory computer-readable storage medium may have an executable stored thereon, which when executed instructs a processor to perform any of the methods described herein.

As shown in FIGS. 5A, 5B, 6, 7, and 8, the controllers 530A, 530B, 630, 730, and/or 830, respectively, may include the processors 533A, 533B, 633, 733, and/or 833, respectively, and the memories 535A, 535B, 635, 735, and/or 835, respectively (which may be one or more non-transitory computer-readable storage media storing instructions executable on processors 533A, 533B, 633, 733, and/or 833, or by controllers 530A, 530B, 630, 730, and/or 830). In some examples, the controller 530A, 530B, 630, 730, and/or 830 may be implemented as hardware, software, and/or a combination of hardware and software in the near-eye display device. In some examples, the controller 530A, 530B, 630, 730, and/or 830 may be implemented, in whole or in part, by at least one of any type of application, program, library, script, task, service, process, or any type or form of executable instructions executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the processor 533A, 533B, 633, 733, and/or 833 may be implemented with a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory 535A, 535B, 635, 735, and/or 835 may be implemented by one or more components (e.g., random access memory (RAM), read-only memory (ROM), flash or solid state memory, hard disk storage, etc.) for storing data and/or computer-executable instructions for completing and/or facilitating the processing and storage functions described herein. In such examples, the memory 535A, 535B, 635, 735, and/or 835 may be volatile and/or non-volatile memory, and may include database components, object code components, script components, or any other type of information structure suitable for implementing the various activities and storage functions described herein.

As would be understood by one of ordinary skill in the art, generally speaking, any one or more of the components and/or functionalities described in reference to any of the FIGS. herein may be implemented by hardware, software, and/or any combination thereof, according to examples of the present disclosure. In some examples, the components and/or functionalities may be implemented by at least one of any type of application, program, library, script, task, service, process, or any type or form of executable instructions stored in a non-transitory computer-readable storage medium executed on hardware such as circuitry that may include digital and/or analog elements (e.g., one or more transistors, logic gates, registers, memory devices, resistive elements, conductive elements, capacitive elements, and/or the like, as would be understood by one of ordinary skill in the art). In some examples, the hardware and data processing components used to implement the various processes, operations, logic, and circuitry described in connection with the examples described herein may be implemented with one or more of a general purpose single- and/or multi-chip processor, a single- and/or multi-core processor, a digital signal processor (DSP), an application specific integrated circuit (ASIC), a field programmable gate array (FPGA), or other programmable logic device, discrete gate or transistor logic, discrete hardware components, and/or any combination thereof suitable to perform the functions described herein. A general purpose processor may be any conventional processor, microprocessor, controller, microcontroller, and/or state machine. In some examples, the memory/storage may include one or more components (e.g., random access memory (RAM), read-only memory (ROM), flash or solid state memory, hard disk storage, etc.) for storing data and/or computer-executable instructions for completing and/or facilitating the processing and storage functions described herein. In some examples, the memory/storage may be volatile and/or non-volatile memory, and may include database components, object code components, script components, or any other type of information structure suitable for implementing the various activities and storage functions described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures/drawings and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An eye/face tracking system in a near-eye device, comprising:
an eye/face tracking light projection system to project structured light onto a user's eye and/or surrounding facial tissue, comprising:
a light source;
a nonlocal metasurface space compressor to receive light from the light source, modify said light, and project the modified light; and
a beam forming element to receive and project the modified light as the structured light onto the user's eye and/or surrounding facial tissue; and
a sensor to capture reflections of the structured light from the user's eye and/or surrounding facial tissue.

2. The eye/face tracking system of claim 1, wherein the eye/face tracking light projection system comprises:
an integrated circuit.

3. The eye/face tracking system of claim 1, wherein the nonlocal metasurface space compressor comprises:
a multilayer polymer spaceplate comprising layers of alternating orthogonally oriented polymers, where the multilayer polymer spaceplate dissipates heat from the light source.

4. The eye/face tracking system of claim 1, wherein the nonlocal metasurface space compressor comprises:
a polarization-sensitive spaceplate to provide different delays for s-polarized and p-polarized light, resulting in a focal plane for the s-polarized light separate from a focal plane for the p-polarized light.

5. The eye/face tracking system of claim 4, wherein the structured light comprises:
a pattern,
wherein the captured reflections of the pattern from the focal plane for the s-polarized light and from the focal plane for the p-polarized light provide depth information.

6. The eye/face tracking system of claim 5, wherein the sensor comprises:
a polarization-sensitive camera to capture a polarization state of the captured reflections,
wherein the captured polarization states of the captured reflections of the pattern from the focal plane for the s-polarized light and from the focal plane for the p-polarized light provide additional depth information.

7. The eye/face tracking system of claim 1, wherein the nonlocal metasurface space compressor comprises at least one of:
a nonlocal spaceplate/metasurface;
a multi-layer metasurface;
a waveguide between two different metasurface layers;
a plurality of layers of alternating waveguides and metasurfaces;
a polarization-sensitive spaceplate;
a photonic crystal slab spaceplate;
a nonlocal multilayer polymer spaceplate; or
a multilayer thin film spaceplate.

8. The eye/face tracking system of claim 1, wherein the light source comprises:
at least one vertical-cavity surface emitting laser (VCSEL).

9. The eye/face tracking system of claim 1, further comprising:
a controller to receive the captured reflections from the sensor and to process the captured reflections for eye/face tracking.

10. An eye/face tracking system in a near-eye device, comprising:
an eye/face tracking nonlocal metasurface space compressed light projector integrated circuit comprising a light source, a nonlocal metasurface space compressor, and a beam-forming element;
a controller communicatively connected to the eye/face tracking nonlocal metasurface space compressed light projector integrated circuit, wherein the controller comprises a processor and a non-transitory computer-readable storage medium storing instructions executable by the processor, and wherein the controller, when executing the instructions, controls the eye/face tracking nonlocal metasurface space compressed light projector integrated circuit to:
project, by the light source, light;
modify, by the nonlocal metasurface space compressor, the projected light from the light source;
pass, by the nonlocal metasurface space compressor, the modified light to the beam-forming element; and
project, by the beam-forming element, the modified light as structured light onto a user's eye and/or surrounding facial tissue, wherein the structured light comprises a pattern;
a sensor to capture images of reflections of the structured light from the user's eye and/or surrounding facial tissue; and
an eye/face tracking controller to process the captured images of reflections of the structured light from the user's eye and/or surrounding facial tissue and to perform eye/face tracking based at least in part on the processing.

11. The eye/face tracking system of claim 10, wherein the nonlocal metasurface space compressor modifies the projected light by providing different delays for s-polarized and p-polarized light, resulting in a focal plane for the s-polarized light separate from a focal plane for the p-polarized light.

12. The eye/face tracking system of claim 11, wherein the eye/face tracking controller processes the captured images of reflections of the structured light from the user's eye and/or surrounding facial tissue by:
obtaining depth information from the captured reflections of the pattern from the focal plane for the s-polarized light and from the focal plane for the p-polarized light.

13. The eye/face tracking system of claim 12, wherein the sensor is further to:
capture a polarization state of the captured reflections.

14. The eye/face tracking system of claim 13, wherein the eye/face tracking controller processes the captured images of reflections of the structured light from the user's eye and/or surrounding facial tissue by:
obtaining additional depth information from the captured polarization states of the captured reflections of the pattern from the focal plane for the s-polarized light and from the focal plane for the p-polarized light.

15. The eye/face tracking system of claim 10, wherein the nonlocal metasurface space compressor comprises at least one of:
a nonlocal spaceplate/metasurface;
a multi-layer metasurface;
a waveguide between two different metasurface layers;
a plurality of layers of alternating waveguides and metasurfaces;
a polarization-sensitive spaceplate;
a photonic crystal slab spaceplate;
a nonlocal multilayer polymer spaceplate; or
a multilayer thin film spaceplate.

16. A method of manufacturing an eye/face tracking nonlocal metasurface space compressed light projector integrated circuit for a near-eye device, comprising:
providing a substrate;
providing layers comprising a vertical cavity surface emitting laser (VCSEL) on the substrate;
providing one or more layers comprising a nonlocal metasurface space compressor on the VCSEL; and
providing one or more layers comprising a beam-forming element on the nonlocal metasurface space compressor;
wherein the eye/face tracking nonlocal metasurface space compressed light projector integrated circuit may be disposed on the near-eye device such that structured light is projected upon a user's eye and/or surrounding facial tissue.

17. The method of manufacturing an eye/face tracking nonlocal metasurface space compressed light projector integrated circuit of claim 14, wherein the nonlocal metasurface space compressor comprises:
a multilayer polymer spaceplate comprising layers of alternating orthogonally oriented polymers, where the multilayer polymer spaceplate dissipates heat from the light source.

18. The method of manufacturing an eye/face tracking nonlocal metasurface space compressed light projector integrated circuit of claim 14, wherein the nonlocal metasurface space compressor comprises:
a multilayer polymer spaceplate comprising layers of alternating orthogonally oriented polymers, where the multilayer polymer spaceplate dissipates heat from the light source.

19. The method of manufacturing an eye/face tracking nonlocal metasurface space compressed light projector integrated circuit of claim 14, wherein the nonlocal metasurface space compressor comprises at least one of:
a nonlocal spaceplate/metasurface;
a multi-layer metasurface;
a waveguide between two different metasurface layers;
a plurality of layers of alternating waveguides and metasurfaces;
a polarization-sensitive spaceplate;
a photonic crystal slab spaceplate;
a nonlocal multilayer polymer spaceplate; or
a multilayer thin film spaceplate.

20. The method of manufacturing an eye/face tracking nonlocal metasurface space compressed light projector integrated circuit of claim 14, wherein the beam-forming element comprises at least one of:
a refractive element;
a reflective element;
a polarization element;
a phase-modification element;
a diffractive grating;
a micro-structure; or
a waveguide.
